(19) United States
(12) Patent Application Publication
(10) Pub. No.: US 2026/0118700 A1
(43) Pub. Date: Apr. 30, 2026

(54) DIFFRACTIVE MULTIFOCAL CONTACT LENS

(71) Applicant: Alcon Inc., Fribourg (CH)

(72) Inventors: Ying Pi, Cumming, GA (US); Cornelius Daniel Niculas, Suwanee, GA (US); Joseph Michael Lindacher, Suwanee, GA (US); Gregory L. Herron, Sugar Hill, GA (US); David Borja, Suwanee, GA (US)

(21) Appl. No.: 19/371,488

(22) Filed: Oct. 28, 2025

Related U.S. Application Data
(60) Provisional application No. 63/713,148, filed on Oct. 29, 2024.

(51) Int. Cl. G02C 7/04; B29D 11/00; G02B 1/04

(52) U.S. Cl. CPC G02C 7/044; B29D 11/00028; B29D 11/00048; B29D 11/00134; G02B 1/043; G02C 2202/20

(57) ABSTRACT

Certain aspects of the present disclosure provide a contact lens with a stepped-transition diffractive design. An example contact lens has an optical zone on its anterior or posterior surface. The optical zone has a circular diffractive zone that has a stepped-transition diffractive surface profile that provides at least one first refractive optical element and at least one diffractive optical element and optionally an annular refractive zone comprising a second refractive optical element. The at least one diffractive optical element comprises a plurality of concentric annular transition surface zones surrounding a central circular area of the contact lens. The stepped-transition surface profile has a monotonically increasing surface sagitta (SAG) in a direction radiating from the central axis of the contact lens.

This application claims the benefit under 35 USC § 119(e) of U.S. provisional application No. 63/713,148 filed 29 Oct. 2024, incorporated by reference in its entirety.

Aspects of the present disclosure relate to the field of vision correction and, more specifically, to a contact lens with smooth or relatively smooth anterior and posterior surfaces and multifocal diffractive optical properties. As defined herein, multifocal diffractive optical properties include distinctive foci at two or more positions.

### BACKGROUND

Presbyopia results from a gradual loss of accommodation of the visual system of the human eye. The loss of accommodation is due to an increase in the modulus of elasticity and growth of the crystalline lens of the eye that is located just behind the iris and the pupil.

In the human eye, a circular ciliary muscle surrounds the crystalline lens. Tiny muscles in the eye called ciliary zonules connect the ciliary muscle to the lens capsule that encloses the crystalline lens. The ciliary zonules pull or release the crystalline lens, thereby causing the curvature of the lens to adjust. Adjustment of the curvature of the crystalline lens results in an adjustment of the eye's focal power to bring objects into focus. For example, when the eyes gaze at an object at a distance, the ciliary muscle relaxes causing the ciliary zonules to become taut, which pulls on the lens to have a flatter curve that is better able to focus incoming light rays from distant objects onto the retina.

In a young eye, accommodation is essentially instantaneous and effortless. As the eye ages, the lens becomes less flexible and elastic, and the ciliary muscle strength decreases. These changes result in the reduction of accommodative amplitude (i.e., loss of accommodation) which causes objects that are close to the eye to appear blurry. The loss of near vision is the hallmark sign of presbyopia in people over the age of, e.g., forty. People that are symptomatic of presbyopia typically have difficulty reading small print, such as that on computer display monitors, restaurant menus, and newspaper advertisements, and may need to hold reading materials at arm's length.

There are a variety of non-surgical corrective systems that are currently used to treat presbyopia, and other conditions such as myopia (e.g., near-sightedness), including bifocal spectacles, progressive (no-line bifocal) spectacles, reading spectacles, bifocal or multifocal contact lenses, mono-vision and monofocal contact lenses. Surgical corrective systems include, for example, multifocal intraocular lenses (IOLs) and accommodation IOLs implanted into the eye and vision systems altered through corneal ablation techniques.

Refractive or diffractive designs may be used for these corrective systems. Refractive designs, however, exhibit limited additive (ADD) power (e.g., the added magnifying power in the lower part of a multi-focal lens), pupil dependency, and a less predictable visual outcomes. Diffractive designs have advantages in application of multifocal ophthalmic devices for presbyopia and have been widely used in IOL products. In cataract surgery, an IOL replaces the natural crystalline lens. IOL power calculations of monofocal implants commonly target distance vision. However, visual requirements at closer distances cannot be satisfied by monofocals and, similar to the case of presbyopia, patients become spectacle dependent to perform their ordinary activity. Multifocal IOLs offer one (bifocals) or two (trifocals) additional focusing distances for near and intermediate vision.

Diffractive multifocal IOLs intentionally induce diffraction so that the waves exiting the lens will have constructive interference at two or more distinct foci at different distances. An in-focus image formed by one focus may be overlaid by one or more secondary out-of-focus images formed by the other foci.

Diffractive bifocal IOLs have a hybrid diffractive-refractive design that consists of a high-power refractive lens (carrier or base lens) and an additive (ADD) low-power diffractive profile engraved on either the front or the back surface of the IOL following a saw tooth pattern of echelettes. The saw tooth pattern of echelettes achieves multifocality, such that a near-dominant central area of the IOL is surrounded by concentric rings of increasing density that result in diffraction of light at both distance and near foci.

Typically, however, diffractive designs have not been widely used commercially in contact lenses (soft or rigid). One reason is that existing diffractive designs have a saw-tooth like surface structure. When such diffractive designs with the saw-tooth like surface structure are applied to the anterior surface of a contact lenses, the diffractive design interacts dynamically with the tear film of the human eye. The “tear film” is a unique thin fluid layer (e.g., approximately 1-3 μm thick and 3 μl in volume) that covers the outer mucosal surfaces of the eye. Every time a person blinks, a thin layer of tear (i.e., the tear film) spreads across the surface the cornea. Tears come from glands above the eye, then drain into tear ducts (small holes in the inner corners of the eyes) and down through the nose. The dynamic interactions with the tear film are difficult to characterize and take into account in the design of the diffractive anterior surface of the contact lens, which results in instability of the visual performance of the contact lens.

In some solutions, the diffractive saw-tooth like structure is placed on the posterior surface of the contact lens. However, the diffractive saw-tooth like structure may be up to a few microns (μm) in surface height and may cause discomfort to the wearer of the contact lens, such as to the cornea of the wearer. In addition, the diffractive saw-tooth like structure may cause corneal molding, where the shape of the cornea is changed by the contact lens.

In some solutions, the diffractive saw-tooth like structure is embedded in a layered or sandwiched structure within the contact lens. Embedding the diffractive structure, however, involves more complex designs, more complicated manufacturing processes, and potentially higher lens material costs.

Accordingly, techniques are needed for improvements in the field of vision correction.

### BRIEF SUMMARY

The present application is generally related to a diffractive multifocal contact lens with smooth or relatively-smooth anterior and posterior surfaces which are free of sawtooth structure but still has multifocal diffractive optical properties.

In certain embodiments, the present application provides a contact lens with a stepped-transition diffractive surface thereon. The contact lens comprises an anterior surface having a first optical zone, an opposite posterior surface having a second optical zone, and a central axis, wherein the first and second optical zones are circular and concentric with the central axis. One of the first and second optical zones comprises a circular diffractive zone and optionally (but preferably) an annular refractive zone surrounding the circular diffractive zone. Both the annular refractive zone and the circular diffractive zone are concentric with the central axis. The circular diffractive zone comprises a stepped-transition diffractive surface that provides a second refractive optical power for a first distant focus and at least one diffractive optical power which is an ADD power needed for a near focus. The annular refractive zone surrounding the circular diffractive zone and has a surface profile that provide a second refractive optical power for a second distant focus. Unlike conventional sawtooth surfaces characteristic of conventional diffractive designs, the stepped-transition diffractive surface has a monotonically increasing surface sagitta (SAG) profile in a direction radiating from the central axis of the contact lens (i.e., from the central axis to the edge of the optical zone).

In certain embodiments, the present application provides an embedded contact lens that comprises: an anterior surface, an opposite posterior surface, a central axis, a first crosslinked polymeric material that constitutes at least 60% by weight of the contact lens in dry state and has a first refractive index, a diffractive insert that is made of a second crosslinked polymeric material having a second refractive index and is embedded in the first crosslinked polymeric material. The second refractive index is at least 0.03 higher than the first refractive index. The diffractive insert is circular or annular in shape and concentric with the central axis of the contact lens and has a front convex surface and a back concave surface. One of the front convex and back concave surfaces comprises, consists essentially, or consists of a diffractive surface that has a stepped-transition diffractive surface that provides a first refractive optical power for a first distant focus and at least one diffractive optical power which is an ADD power needed for a near focus. The stepped-transition diffractive surface has a monotonically increasing surface sagitta (SAG) profile in a direction radiating from the central axis of the contact lens.

Certain embodiments provide a method for forming a contact lens with a stepped-transition diffractive surface which is its posterior surface or preferably its anterior surface. The method generally includes designing a contact lens having an anterior surface having a first optical zone, an opposite posterior surface having a second optical zone, and a central axis, wherein the first and second optical zones are circular and concentric with the central axis, wherein one of the first and second optical zones comprises a circular diffractive zone and optionally (but preferably) an annular refractive zone surrounding the circular diffractive zone, wherein both the annular refractive zone and the circular diffractive zone are concentric with the central axis, wherein the circular diffractive zone has a stepped-transition diffractive surface that provides at least one first refractive optical power for a first distant focus and at least one diffractive optical power which is an ADD power needed for a near focus, wherein the annular refractive zone has a surface profile that provide a second refractive optical power for a second distant focus, wherein the stepped-transition diffractive surface has a monotonically increasing surface sagitta (SAG) in a direction radiating from the central axis of the contact lens; and producing the contact lens by lathing or molding.

Certain embodiments provide a method for forming an embedded contact lens that comprises: an anterior surface, an opposite posterior surface, a first crosslinked polymeric material that constitutes at least 70% by weight of the lens body in dry state and has a first refractive index, a diffractive insert that is made of a second crosslinked polymeric material having a second refractive index and is embedded in the first crosslinked polymeric material, wherein the second refractive index is at least 0.03 higher than the first refractive index, wherein the diffractive insert is circular or annular in shape and concentric with the central axis of the lens body and has a front convex surface and a back concave surface, wherein one of the front convex and back concave surfaces comprises, consists essentially, or consists of a stepped-transition diffractive surface that has a stepped-transition diffractive surface that provides at least one first refractive optical power for a first distant focus and at least one diffractive optical power which is an ADD power needed for a near focus, wherein the stepped-transition diffractive surface has a monotonically increasing surface sagitta (SAG) profile in a direction radiating from the central axis of the lens body); and producing the contact lens by lathing or molding.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

The appended figures depict certain aspects of the one or more embodiments and are therefore not to be considered limiting of the scope of this disclosure.

FIG. 1A depicts a top view of an example contact lens with a stepped-transition diffractive design, in accordance with certain aspects described herein.

FIG. 1B depicts a side view of the example contact lens of FIG. 1A, in accordance with certain aspects described herein.

FIG. 2 depicts an example of a surface profile of a diffractive component of the circular diffractive zone of the example contact lens of FIGS. 1A-1B, in accordance with certain aspects described herein.

FIG. 3 depicts an example modulation transfer function (MTF) of the example contact lens of FIGS. 1A-1B and 2, in accordance with certain aspects described herein.

FIG. 4 depicts a side view of the example embedded multifocal contact lens, comprising a diffractive insert including a stepped-transition diffractive design, in accordance with certain aspects described herein.

FIG. 5 illustrates an example system for designing, configuring, and/or forming a contact lens with a stepped-transition diffractive design, in accordance with certain aspects described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

“About” as used herein in this application means that a number, which is referred to as “about”, comprises the recited number plus or minus 1-10% of that recited number.

“Contact Lens” refers to a structure that can be placed on or within a wearer's eye. A contact lens can correct, improve, or alter a user's eyesight, but that need not be the case. A contact lens can be made of any appropriate material known in the art or later developed, and can be a soft lens, a hard lens, or an embedded contact lens.

A “hydrogel contact lens” refers to a contact lens the bulk lens material of which is a hydrogel material. A hydrogel bulk material can be a non-silicone hydrogel material or preferably a silicone hydrogel material. A bulk lens material in reference to a material that constitutes at least 60% by weight of a dry hydrogel contact lens (i.e., excluding water).

A “hydrogel” or “hydrogel material” refers to a crosslinked polymeric material which has three-dimensional polymer networks (i.e., polymer matrix) comprising repeating units of at least one hydrophilic vinylic monomer, is insoluble in water, but can hold at least 10% by weight of water in its polymer matrix when it is fully hydrated (or equilibrated).

A “silicone hydrogel” or “SiHy” refers to a silicone-containing hydrogel obtained by copolymerization of a polymerizable composition comprising at least one silicone-containing monomer or at least one silicone-containing macromer or at least one cross linkable silicone-containing prepolymer in addition to at least one hydrophilic vinylic monomer.

A “siloxane,” which often also described as a “silicone,” refers to a moiety of —Si—O—Si— where each Si atom carries two organic groups as substituents. A polysiloxane refers to a moiety of —Si—O—(Si—O)n-Si— in which each Si atom carries two organic groups as substituents and n is an integer of 2 or greater.

As used in this application, the term “non-silicone hydrogel” or “non-silicone hydrogel material” interchangeably refers to a hydrogel that is theoretically free of silicon.

The “anterior surface”, “front surface”, “front curve surface” or “FC surface” in reference to a contact lens, as used in this application, interchangeably means a surface of the contact lens that faces away from the eye during wear. The anterior surface (FC surface) is convex.

The “posterior surface”, “back surface”, “base curve surface” or “BC surface” in reference to a contact lens, as used in this application, interchangeably means a surface of the contact lens that faces towards the eye during wear. The posterior surface (BC surface) is concave.

The term “central axis” in reference to a contact lens, as used in this application, means mean an imaginary reference line passing through the geometrical centers of the anterior and posterior surfaces of a contact lens.

An “embedded contact lens” refers a contact lens comprising at least one insert which is embedded within the bulk hydrogel material of the embedded contact lens to an extend that at most only one of the anterior or posterior surfaces of the insert can be exposed fully or partially. It is understood that the crosslinked polymeric material of the insert is different from the bulk lens material of the embedded contact lens. An insert should have a thickness less than any thickness of an embedded contact lens in the region where the insert is embedded.

The “front convex surface” in reference to an insert embedded in a contact lens, as used in this application, interchangeably means a surface of the insert that faces away from the eye during wear of the embedded contact lens.

The “back concave surface” in reference to an insert embedded in a contact lens, as used in this application, interchangeably means a surface of the insert that faces towards the eye during wear of the embedded contact lens.

A “male mold half” or “base curve mold half” interchangeably refers to a mold half having a molding surface that is a substantially convex surface and that defines the posterior surface of a contact lens or an insert.

A “female mold half” or “front curve mold half” interchangeably refers to a mold half having a molding surface that is a substantially concave surface and that defines the anterior surface of a contact lens or an insert.

A “central axis” in reference to a mold half, as used in this application, means an imaginary reference line passing normally (i.e., normal to the molding surface) at the geometrical center) of the molding surface of the mold half.

The term “diameter” in reference to a contact lens or a circular insert, as used in this application, means the width of the contact lens or the circular insert from edge to edge.

The term “outer diameter” in reference to an annular insert, as used in this application, means the width of the annular insert from outer edge (i.e., having a longer radial distance from the central axis) to outer edge. The term “inner diameter” in reference to an annular insert, as used in this application, means the width of the annular insert from inner edge (i.e., having a shorter radial distance from the central axis) to inner edge.

As used herein, a “stepped-transition diffractive surface” is intended to describe a diffractive structure that is created (1) on the circular diffractive zone of one of the anterior and posterior surfaces of a contact lens or (2) on one of the front convex surface and the back concave surface of a diffractive insert embedded in a contact lens comprises a plurality of annular curved surface zones (i.e., annular refractive surface zones), a plurality of annular transition zones (i.e., annular diffractive surface zones), and optionally one circular curved central surface zone. The circular curved central surface zone, the plurality of the annular curved surface zone and the plurality of the annular transition zones all are concentric with the central axis of a contact lens. Each of the plurality of the annular transition zones creates one sharp change in SAG (i.e., substantially similar to vertical parts of steps of a stair) between the circular curved central surface zone (i.e., similar to a horizontal part of a step of a stair) and nearest annular curved surface zone or between two adjoining annular curved surface zones (i.e., similar to horizontal parts of steps of a stair). The transition zones optically function to provide diffractive optical properties, and the circular curved central surface zone and the annular curved surface zones provide refractive optical properties. Where the stepped-transition diffractive surface is circular, it comprises the circular curved central surface zone. Wherein the stepped-transition diffractive surface is annular, it is free of the circular curved central surface zone.

As used herein, an “aspherical surface” is intended to describe a rotationally symmetrical surface which is not spherical.

Aspects of the present disclosure provide two types of multifocal contact lenses each comprising an unconventional diffractive structure (i.e., a stepped-transition diffractive surface) thereon or therein for providing multifocal diffractive optical properties. The diameter of the contact lens (i.e., measured at the edge of the contact lens) may be between about 12.5 mm to about 15.5 mm, preferably between about 13.0 mm to about 15.2 mm, more preferably between about 13.5 mm to about 14.8 mm.

1^{st} Type of Multifocal Contact Lenses with a Stepped-Transition Diffractive Design

The first type of multifocal contact lenses of the invention is a contact lens comprising a stepped-transition diffractive structure created on either the anterior surface or the posterior surface of the contact lens. Such a contact lens of the invention comprises an anterior surface having a first optical zone, an opposite posterior surface having a second optical zone, and a central axis, wherein the first and second optical zones are circular and concentric with the central axis. The first and second optical zones have a diameter (i.e., measured at the edge of the optical zone) of from about 5.0 to about 11.0 mm, preferably from about 6.0 to about 10.5 mm, more preferably from about 6.5 to 10.0 mm, even more preferably from about 7.0 to about 9.5 mm.

One of the first and second optical zones comprises, essentially consists of, or consists of a circular diffractive zone and optionally (but preferably) an annular refractive zone surrounding the circular diffractive zone. Both the circular diffractive zone and the annular refractive zone are concentric with the central axis.

The circular diffractive zone has a monotonically increasing surface sagitta (SAG) profile in a direction radiating from the central axis of the contact lens (i.e., from the central axis to the edge of the circular diffractive zone) and comprises (or consists essentially of or consists of) a circular stepped-transition diffractive surface that provides at least one first refractive optical power and at least one diffractive optical power.

The circular stepped-transition diffractive surface comprises, consists essentially of, or consists of one circular curved central surface zone, a plurality of annular curved surface zones, and a plurality of annular transition zones. The circular curved central surface zone, the plurality of the annular curved surface zone and the plurality of the annular transition zones all are concentric with the central axis of the contact lens. Each of the plurality of the annular transition zones creates one sharp change in SAG between the circular curved central surface zone and nearest annular curved surface zone or between two adjoining annular curved surface zones. The annular transition zones optically function to provide diffractive optical properties, and the circular curved central surface zone and the annular curved surface zones provide refractive optical properties.

The circular diffractive zone can have a diameter of from about 2.0 mm to about 7.5 mm, preferably from about 2.5 mm to about 7.0 mm, more preferably from about 3.0 mm to about 6.5 mm, even more preferably from about 3.5 mm to about 6.0 mm.

The circular curved central surface zone, the annular curved surface zones and the annular transition zones of the circular diffractive zone can be spherical or aspherical surfaces which preferably has substantially identical surface curvatures (i.e., provide one substantially identical refractive power).

Each of the annular transition zones of the circular stepped-transition diffractive surface has a start, an end, a width, and a height. An annular transition zone start is the inner edge of that particular annular transition zone (i.e., having a shorter radial distance from the central axis) whereas an annular transition zone end is the outer edge of the that particular annular transition zone (i.e., having a longer radial distance from the central axis). An annular transition zone width is a difference in radial distance between the annular transition zone start and the annular transition zone end of that particular annular transition zone. An annular transition zone height (or annular transition zone step height or annular transition step height) is a difference in SAG between the annular transition zone start and the annular transition end of each annular transition zone. Preferably, all the annular transition zones have an annular transition zone width of about 0.1 mm or less (preferably about 0.08 mm or less, more preferably about 0.06 mm or less, even more preferably about 0.05 mm or less).

In some embodiments, the circular stepped-transition diffractive surface is continuous in second derivative. Namely, all injunctions between an annular curved surface zone (or the circular curved central surface zone) and an annular transition zone are continuous in second derivative. Such injunctions can be designed by using a continuous piecewise function.

Unlike conventional saw-tooth diffractive structure (i.e., surface profile) created on a lens surface, an unconventional diffractive structure created on one of the anterior and posterior surfaces of a contact lens of the invention has a “stepped-transition” diffractive structure has a continuous, monotonically increasing surface Sagitta (SAG) in a radial direction from the central axis to the edge of the optical zone of the contact lens. Such a “stepped-transition” diffractive surface is relatively smoother or more continuous as compared to a saw-tooth like surface profile for a conventional diffractive design.

For a typical diffractive IOL deployed in a stable environment (e.g., implanted and not interacting with a tear film or eye lid), zeroth order diffraction is used for the distance focus and a non-zero order diffraction is used for the near focus. According to embodiments of the present disclosure, the stepped-transition diffractive design involves zeroth order diffraction for near focus and a higher non-zero order diffraction (e.g., −1) for distance focus. For example, for bifocal diffractive design, zeroth order diffraction may be used for the near focus and minus order diffraction may be used for the distance focus. For a trifocal design, zeroth order diffraction may be used for the near focus and a higher order diffraction is used for the intermediate and distance focus. For example, zeroth order diffraction may be used for the near focus, −1 order diffraction may be used for the intermediate focus, and −2 order diffraction may be used for the distance focus. In another example, zeroth order diffraction may be used for the near focus, −2 order diffraction may be used for the intermediate focus, and −3 order diffraction may be used for the distance focus.

In some embodiments, the stepped-transition diffractive design is created on the anterior surface of the contact lens. For example, the stepped-transition diffractive design may be created in an optical zone of the anterior surface of the contact lens. As used herein, the “optical zone” of the contact lens may refer to a center portion of the contact lens that provides the corrective power of the contact lens. The stepped-transition diffractive design created on the anterior surface of a contact lens may reduce the interactions with the tear film of the wearer of the contact lens, providing improved vision performance, as compared to a lens with a typical saw-tooth diffractive design.

In some embodiments, the stepped-transition diffractive design is created on the posterior surface of the contact lens. For example, the stepped-transition diffractive design may be created in an optical zone of the posterior surface of the contact lens. The stepped-transition diffractive design may reduce or eliminate discomfort to the wearer of the contact lens as compared to a lens with a typical saw-tooth diffractive design.

The annular refractive zone has a surface profile that provide a second refractive optical power. The annular refractive zone can have a spheric surface or an aspheric surface. It is understood that the annular refractive zone is substantially free of (preferably free of) any diffractive structure.

In some embodiments, the stepped-transition diffractive design is created for contact lenses in both eyes of the wearer. In some embodiments, the diffractive multifocal contact lens with a stepped-transition diffractive design is created in one eye of the wearer, while a different type of lens is used in the other eye of the wearer. For example, the diffractive multifocal contact lens with a stepped-transition diffractive design may be created in a contact lens worn on the non-dominant eye of the wearer and a different type of contact lens, such as a refractive contact lens, may be worn on the dominant eye. In another example, the diffractive multifocal contact lens with a stepped-transition diffractive design may be created in a contact lens worn on the dominant eye of the wearer and the different type of contact lens may be worn on the non-dominant eye of the wearer. As used herein, the “dominant” eye may refer to the eye that maintains the same fixation in binocular of monocular viewing, is used more, or has better vision. In some embodiments, the diffractive multifocal contact lens with a stepped-transition diffractive design may provide better results when worn in the dominant as compared to when worn in the non-dominant eye.

Accordingly, a contact lens may be provided with a stepped-transition diffractive design, that has a relatively smooth surface, that reduces discomfort to the wearer and interactions with the tear film, where the diffractive design can be applied on the anterior or posterior surface of the contact lens, avoiding changes to the manufacturing process for the contact lens or additional material of an embedded design.

The first type of multifocal contact lenses of the invention can be made of a non-silicone hydrogel material or a silicone hydrogel material or a rigid gas permeable material as bulk lens material. Non-silicone hydrogel materials, silicone hydrogel materials and rigid gas permeable materials are well known to a person skilled in the art and also extensively disclosed in patents and published patent applications. Examples of preferred non-silicone hydrogel materials and silicone hydrogel materials are described later in this application.

2^{nd} Type of Multifocal Contact Lenses with a Stepped-Transition Diffractive Design

The second type of multifocal contact lenses of the invention is a contact lens comprising a stepped-transition diffractive structure created on a buried surface of a diffractive insert which is embedded in the bulk lens material (i.e., first crosslinked polymeric material) of the contact lens (i.e., embedded contact lens). Such a contact lens of the invention comprises: an anterior surface, an opposite posterior surface, a central axis, a first crosslinked polymeric material that constitutes at least 60% by weight of the contact lens in dry state and has a first refractive index, a diffractive insert that is made of a second crosslinked polymeric material having a second refractive index and is embedded in the first crosslinked polymeric material. The second refractive index is at least 0.03 (preferably at least 0.04, more preferably at least 0.05, even more preferably 0.07) higher than the first refractive index.

The diffractive insert (which is embedded in a contact lens of the invention) comprises a front convex surface and an opposite back concave surface and is circular or annular in shape and is concentric with the central axis of the contact lens. At least one of the front convex and back concave surfaces is buried completely inside the embedded contact lens and directly in contact with the first crosslinked polymeric material and is designated as a buried surface of the diffractive insert. The buried surface of the diffractive insert has a monotonically increasing surface sagitta (SAG) profile in a direction radiating from the central axis of the contact lens and comprises, consists essentially of, or consists of a stepped-transition diffractive surface.

A circular diffractive insert of the invention has a diameter of from about 2.0 mm to about 7.5 mm, preferably from about 2.5 mm to about 7.0 mm, more preferably from about 3.0 mm to about 6.5 mm, even more preferably from about 3.5 mm to about 6.0 mm. The stepped-transition diffractive surface comprises, consists essentially of, or consists of one circular curved central surface zone, a plurality of annular curved surface zones, and a plurality of annular transition zones. The circular curved central surface zone, the plurality of the annular curved surface zone and the plurality of the annular transition zones all are concentric with the central axis of the embedded contact lens. Each of the plurality of the annular transition zones creates one sharp change in SAG between the circular curved central surface zone and nearest annular curved surface zone or between two adjoining annular curved surface zones. The annular transition zones optically function to provide diffractive optical properties, and the circular curved central surface zone and the annular curved surface zones provide refractive optical properties.

An annular diffractive insert has an inner diameter (i.e., measured at the inner edge of the insert) of from about 0.5 mm to about 3.0 mm, preferably from about 0.5 mm to about 2.5 mm, more preferably from about 0.5 mm to 2.0 mm, even more preferably from about 0.5 mm to about 1.5 mm, and an outer diameter of about 7.5 mm or less, preferably about 7.0 mm or less, more preferably from about 6.5 mm or less, even more preferably from about 6.0 mm or less. The stepped-transition diffractive surface comprises, consists essentially of, or consists of a plurality of annular curved surface zones and a plurality of annular transition zones. The plurality of the annular curved surface zone and the plurality of the annular transition zones all are concentric with the central axis of the embedded contact lens. Each of the plurality of the annular transition zones creates one sharp change in SAG between two adjoining annular curved surface zones. The annular transition zones optically function to provide diffractive optical properties, and the annular curved surface zones provide refractive optical properties.

Each of the annular transition zones of a stepped-transition diffractive surface has a start, an end, a width, and a height. An annular transition zone start is the inner edge of that particular annular transition zone (i.e., having a shorter radial distance from the central axis) whereas an annular transition zone end is the outer edge of the that particular annular transition zone (i.e., having a longer radial distance from the central axis). An annular transition zone width is a difference in radial distance between the annular transition zone start and the annular transition zone end of that particular annular transition zone. An annular transition zone height (or annular transition zone step height or annular transition step height) is a difference in SAG between the annular transition zone start and the annular transition end of each annular transition zone. Preferably, all the annular transition zones have an annular transition zone width of about 0.1 mm or less (preferably about 0.08 mm or less, more preferably about 0.06 mm or less, even more preferably about 0.05 mm or less).

In some embodiments, the stepped-transition diffractive surface is continuous in second derivative. Namely, all injunctions between an annular curved surface zone (or the circular curved central surface zone) and an annular transition zone are continuous in second derivative. Such injunctions can be designed by using a continuous piecewise function.

In some preferred embodiments, the front convex surface of a diffractive insert of the invention merges with and becomes an integral part of the anterior surface of the embedded contact lens whereas the back concave surface is buried completely inside and in contact directly with the first crosslinked polymeric material and comprises, consists essentially of, or consists of the stepped-transition diffractive surface.

In other preferred embodiments, the back concave surface merges with and becomes an integral part of the posterior surface of the embedded contact lens whereas the front convex surface is buried completely inside and in contact directly with the first crosslinked polymeric material and comprises, consists essentially of, or consists of the stepped-transition diffractive surface.

The first crosslinked polymeric material (i.e., the bulk lens material of the embedded contact lens) can be any non-silicone hydrogel materials or any silicone hydrogel materials. Non-silicone hydrogel materials and silicone hydrogel materials are well known to a person skilled in the art and have been extensively disclosed in patents and published patent applications. Examples of preferred non-silicone hydrogel materials and silicone hydrogel materials are described later in this application.

The second crosslinked polymeric material (i.e., the insert material) can be any non-silicone hydrogel materials, any silicone hydrogel materials or any rigid gas permeable materials, so long as they are different from the first crosslinked polymeric materials and has a refractive index higher than the refractive index of the first crosslinked polymeric material. Examples of preferred non-silicone hydrogel materials and silicone hydrogel materials for forming the bulk lens materials and for forming inserts are described later in this application.

Example Contact Lens with a Stepped-Transition Diffractive Design

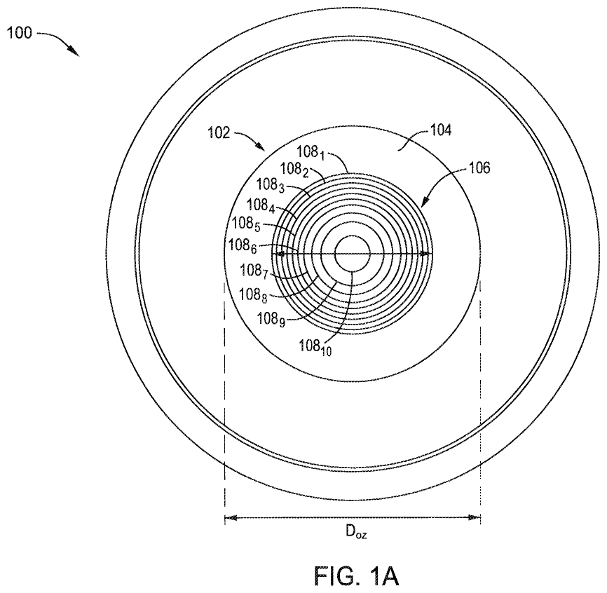

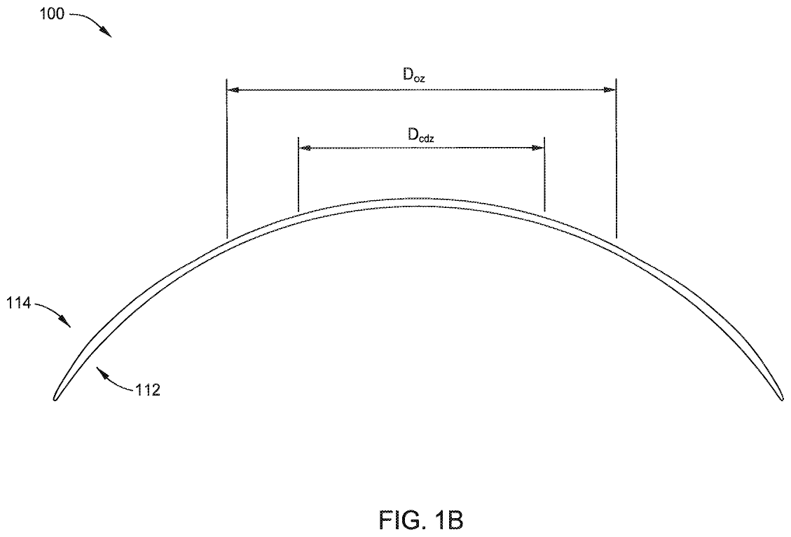

FIG. 1A depicts a top view of an example contact lens 100 with a stepped-transition diffractive design, in accordance with certain aspects described herein. FIG. 1B depicts a side view of the example contact lens 100 of FIG. 1A, in accordance with certain aspects described herein. Although FIG. 1A and FIG. 1B illustrate example contact lens 100 with the stepped-transition diffractive design on the anterior (“front”) surface 114 of contact lens 100, it should be understood that in some embodiments, the stepped-transition diffractive design may be located on the posterior (“back”) surface 112 of contact lens 100.

Contact lens 100 may be spherical, aspherical, or toric. The thickness of contact lens 100 may be between 0.07 mm to 0.40 mm. Contact lens 100 may be a hard contact lens or a soft contact lens. Contact lens 100 may be made of any known lens material, including hydrogel and silicone hydrogel materials. Soft contact lenses are flexible, easy to adjust, and register to the cornea better than hard contact lenses. Soft contact lenses allow oxygen to pass through them. Hard contact lenses may be more durable, but not as flexible as soft contact lenses. Hard contacts are made of a stiffer material (e.g., polymethyl methacrylate) than what is used for soft contact senses and do not mold to the shape of the eye. Rigid gas permeable contact lenses, made of silicone-containing compounds, allow oxygen to pass through the eye.

As shown in FIG. 1A, contact lens 100 includes an optical zone 102 on its anterior surface 114. Optical zone 102 includes an annular refractive zone 104 and a circular diffractive zone 106. As shown in FIG. 1A, contact lens 100, optical zone 102 and circular diffractive zone 106 are each generally circular whereas annular refractive zone 104 is annular, in plan profile (i.e., view from above or below). Contact lens 100 may have a diameter in a range from around 12.5 mm to 15.5 mm, typically between 13 mm to 15.2 mm. Optical zone 102 may have a diameter (D_{oz}) in a range from 5 mm to 10.5 mm, typically between 6.0 mm to 9.5 mm.

As shown in FIG. 1B, contact lens 100 includes a posterior surface 112 and anterior surface 114. The posterior surface 112 has a base curvature for fitting to the human eye. The radius of the base curvature may be in a range from 7 mm to 10 mm, typically between 8 mm to 9 mm. A higher base curvature radius value may be fitted for an eye with a flatter cornea compared to a lower base curvature radius for an eye with a steeper cornea.

Annular refractive zone 104 is a refractive mono-focal zone. Annular refractive zone 104 provides optical power for distance. Annular refractive zone 104 may have an outer diameter corresponding to the diameter (D_{oz}) of the optical zone 102 and an inner diameter corresponding to the diameter (D_{cdz}) of the circular diffractive zone 106. Annular refractive zone 104 may be a spherical or aspherical surface.

Circular diffractive zone 106 may be a diffractive bifocal zone. In some embodiments, circular diffractive zone 106 includes a base refractive component (e.g., an even asphere) and a diffractive component. The base refractive component may be the same as or different from the annular refractive zone 104. The refractive component may provide performance at a distance focus. The refractive component may be a simple spherical curve or an aspheric curve that compensates for spherical aberrations in the eye or provides extended depth-of-focus. The diffractive component provides performance at the near focus.

Circular diffractive zone 106 may have a diameter (D_{cdz}) in a range from 2 mm to 7 mm, typically between 3 mm and 6 mm. As shown, circular diffractive zone 106 includes multiple concentric transition zones 108₁ . . . 108₁₀ (collectively referred to as concentric transition zones 108) created on the surface of contact lens 100. While ten concentric transition zones 108 are shown in FIG. 1A, fewer or more concentric transition zones may be included in circular diffractive zone 106.

The surface profile of optical zone 102 can be given as:

$$Z = {Z}_{cdz} + {Z}_{arz} ,$$

where Z_{cdz} is the surface profile of circular diffractive zone 106, including the refractive component and the diffractive component, and Z_{arz} is the surface of annular refractive zone 104. Z_{cdz} and Z_{arz} may be represented by a polynomial up to the tenth order.

The surface profile of circular diffractive zone 106, Zᵢₙₙₑᵣ, is represented by the surface profiles of the refractive and diffractive components of the circular diffractive zone 106, given by:

$${Z}_{cdz} ( r ) = {Z}_{ref \_ cdz} ( r ) + {Z}_{dif \_ cdz} ( r ) , for 0 \leq r \leq {r}_{cdz \_ max} ,$$

where r is the semi-diameter (radius) of the circular diffractive zone 106 and r_{cdz_max} is the maximum semi-diameter (radius) of circular diffractive zone 106. The value of r_{cdz_max} may be in range of 1.25 mm to 2.25 mm.

The surface profile of the refractive component, Z_{ref_cdz}(r), of the circular diffractive zone 106 is given by:

$${Z}_{ref \_ cdz} ( r ) = \frac{{C}_{cdz} {r}^{2}}{1 + \sqrt{1 - ( 1 + {K}_{cdz} ) {{C}_{cdz}}^{2} {r}^{2}}} + {a}_{1} {r}^{4} + {a}_{2} {r}^{6} + {a}_{3} {r}^{8} + {a}_{4} {r}^{10} , where {C}_{cdz} = \frac{1}{{R}_{cdz}} ,$$

R_{cdz} is the radius of curvature of the refractive component of the circular diffractive zone 106. R_{cdz} may vary with lens power, radius of the lens base surface, refractive index, or other parameters. R_{cdz} may have a value in range of 6 mm to 12 mm. K_{cdz} is the conic constant of the refractive component of the circular diffractive zone 106. For a sphere, K_{cdz}=0. The parameters a₁, a₂, a₃, and a₄ are the 2^{nd}, 4^{th}, 6^{th}, and 10^{th} order polynomial coefficients, respectively, of the refractive component of the circular diffractive zone 106. The coefficients a₁, a₂, a₃, and a₄ define a power profile of the circular diffractive zone 106. The coefficients a₁, a₂, a₃, and a₄ are for an asphere component of the refractive component of the circular diffractive zone 106, for a pure conic base a₁=a₂=a₃=a₄=0.

The surface profile of the diffractive component, Z_{dif_cdz}(r), of the circular diffractive zone 106 is given by:

$${Z}_{dif \_ cdz} ( r ) = \frac{λ}{1000 \cdot ( N - 1 )} \cdot OPD ( r ) ,$$

where
λ is a design wavelength (e.g., 546 nm); and N is the refractive index of the material of contact lens 100. The value of N may be in a range of 1.38 to 1.45. OPD is the optical path difference. OPD is given by:

$$OPD ( r ) = ( n - 1 ) - α \cdot [ ( n - 1 ) - \frac{1}{2} \cdot \frac{ADD}{λ} \cdot {r}^{2} ] for {r}_{n - 1} \leq r \leq {r}_{n} ,$$

where α determines the energy split of the two foci. α may have a value in a range 0.4≤α≤1. For larger values of a, more light energy goes to the near focus and for smaller values of a less light energy goes to the distance focus. For example, for a value of α=1, all light energy goes to the near focus. ADD is an additional corrective power of the contact lens 100 needed for near focus (i.e., reading or other close-up visual tasks) and is expressed in diopters. The ADD power may be in a range from 1 D to 3 D. rₙ is the diameter of the diffractive component of circular diffractive zone 106. rₙ is given by:

$${r}_{n} = \sqrt{2 n \cdot \frac{λ}{ADD}} for n = 1 , 2 , 3 , … {n}_{max} ,$$

where r₀=0, r_{n_max}<r_{cdz_max}, and where r_{n_max} is the maximum size of the diffractive component; and nₘₐₓ is the maximum number of diffractive inner zones (e.g., concentric transition zones 108). The value of nₘₐₓ may depend on the ADD power for a given λ and r_{cdz_max}. For example, a higher nₘₐₓ may be used for a higher ADD power. The value of nₘₐₓ may be in a range from 5 to 10.

The surface profile of annular refractive zone 104, Z_{arz}, is given by:

$${Z}_{arz} ( r ) = \frac{{C}_{arz} {r}^{2}}{1 + \sqrt{1 - ( 1 + {K}_{arz} ) {{C}_{arz}}^{2} {r}^{2}}} + {b}_{1} {r}^{4} + {b}_{2} {r}^{6} + {b}_{3} {r}^{8} + {b}_{4} {r}^{10} + Δ Z for \leq {r}_{cdz \_ max} \leq r \leq {r}_{oz} ,$$

where b₁, b₂, b₃, and b₄ are the 2^{nd}, 4^{th}, 6^{th}, and 10^{th} order polynomial coefficients, respectively, of the annular refractive zone 104. The coefficients b₁, b₂, b₃, and b₄ define a power profile of the annular refractive zone 104. The coefficients b₁, b₂, b₃, and b₄ are for an asphere component of the annular refractive zone 104, for a pure conic base b₁=b₂=b₃=b₄=0. C_{arz} is given by:

$${C}_{arz} = \frac{1}{{R}_{arz}}$$

where R_{arz} is the radius of curvature of the annular refractive zone 104; the value of R_{arz} may vary with lens power, radius of the lens base surface, N, or other parameters; the value of R_{arz} may be in a range from 6 mm to 12 mm; K_{arz} is the conic constant of the annular refractive zone 104; for a sphere, K_{arz}=0; r_{oz} is the semi-diameter of the optical zone 102; the value of r_{oz} may be in a range of 3.5 mm to 4.5 mm; and AZ is the surface SAG height different between the annular refractive zone 104 and the circular diffractive zone 106 at the intersection point, r_{cdz_max}, and is given by:

$$Δ Z = {Z}_{arz} ( {r}_{cdz \_ max} ) - {Z}_{cdz} ( {r}_{cdz \_ max} )$$

As mentioned above, the refractive component of the circular diffractive zone 106 can be exactly the same as the annular refractive zone 104. That is, R_{arz}=R_{cdz}, K_{arz}=K_{cdz}, and a₁=b₁, a₂=b₂, a₃=b₃, and a₄=b₄. In some embodiments, the refractive component of the circular diffractive zone 106 is different from that of the annular 104.

In some embodiments, one or more of the above parameters of contact lens 100 may be fixed, while one or more other of the parameters of contact lens 100 are variables and may be optimized for a particular design.

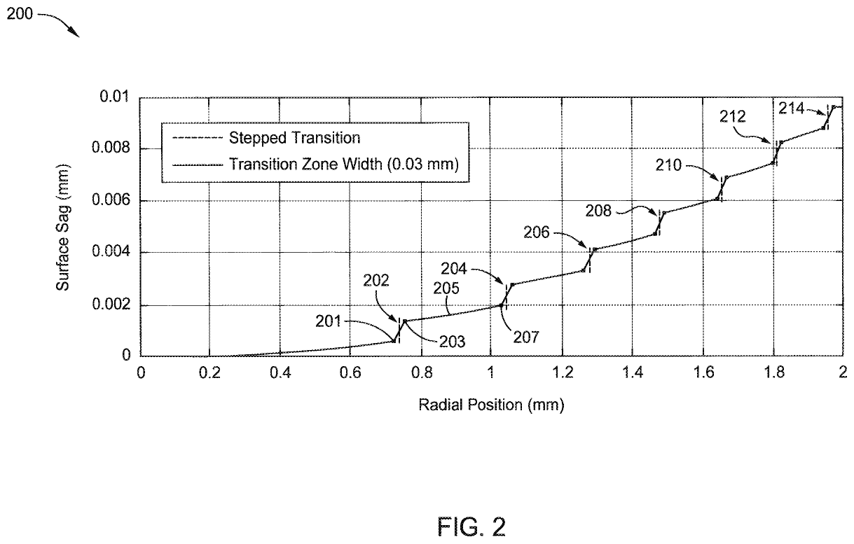

FIG. 2 depicts an example surface profile 200 over a diffractive component of the circular diffractive zone 106 of the example contact lens 100 of FIGS. 1A-1B, in accordance with certain aspects described herein. The surface profile of the diffractive component includes transition zones 202, 204, 206, 208, 210, 212, and 214. Each transition zone includes a transition zone start and a transition zone end. As shown, transition zone 202 has a transition zone start 201 and a transition zone end 203. In the illustrated example, the following values are used for the parameters of contact lens 100 discussed above: K_{arz}=0, K_{cdz}=0, a₁=a₂=a₃=a₄=0, b₁=b₂=b₃=b_{4q=0}, r_{cdz_max}=2 mm, r_{oz}=4 mm, λ=546 nm, lens base curve radius of curvature=8.31 mm, lens base curve conic=0, ADD=2 D, N=1.4, lens center thickness=0.14 mm, lens distance power=0 D, α=0.48, and nₘₐₓ=8.

As shown, the surface SAG continuously and monotonically increases with the radial position from the center of the optical zone 102, defining a step-like surface profile. The surface SAG of the contact lens represents the distance from the center of the lens to the plane that the edges circumscribe. As shown in FIG. 2, the surface SAG increases steeply within each transition zone, as compared to the other portions of the surface. For example, in the embodiment shown in FIG. 2, the transition zone width (the change in radial position during the stepped transition, e.g., the radial distance between transition zone start 201 and a transition zone end 203), rₙ, is 0.03 mm during which the surface SAG increases by around 0.001 mm. In FIG. 2, the transition zone height (α) (i.e., the difference in SAG between the transition zone start and the transition end of each transition zone, or so-called “transition step height”) for each transition zone is shown with a dashed vertical line.

In addition, the surface SAG monotonically increases in between each of the transition zones 202, 204, 206, 208, 210, 212, and 214. For example, as shown in FIG. 2, the surface SAG monotonically increases in the surface portion 205 of contact lens 100 between the transition zone end 203 of transition zone 202 and the transition zone start 207 of transition zone 204. In some embodiments, the surface SAG increases according to a curvature which can be different from or (preferably) equal to the curvature of the annular refractive zone 104 of contact lens 100 in the surface portions between the transition zones 202, 204, 206, 208, 210, 212, and 214.

In some embodiments, the distance between the stepped transitions (e.g., the width of the curved surface portions between the transition zone ends and transition zone starts) may decrease towards the edge of the contact lens 100, as shown in FIG. 2. It should be noted that while FIG. 2 illustrates seven stepped transitions, fewer or more stepped transitions may be used in the diffractive component for contact lens 100. In some embodiments, the transition zone heights (aka., transition step heights) and transition zone widths are the same in each of the transition zones. In some embodiments, the transition zone heights and transition zone widths are different for different transition zones.

The stepped transitions provide small surface structures in the diffractive component. The small surface structures provide the constructive interference to achieve the multi-focality of the diffractive design. The discrete stepped transitions introduce discontinuities in the wavefront emerging from the contact lens 100. As the disjointed wavefront propagates to the retina, the disjointed waves begin to overlap, leading to constructive interference in the neighborhood of the two foci.

The transition zone width (rₙ) determines how much ADD power is provided by the optical zone 102. The size (i.e., the “height” or “amplitude”) of each stepped transition (α) determines the energy distribution from each focus. In some embodiments, the transition step heights are apodized. Apodization is the gradual tapering of diffractive transition steps from the center of the contact lens 100 towards the outside edge. Apodization may be used to further adjust the energy distribution between the near and distance foci.

In some embodiments, phase apodization is an additional design parameter to deliver variable energy distribution between the two or more foci within the circular diffractive zone.

In some embodiments, the size of the stepped transitions and the transition zone widths may be selected so that light waves passing through the contact lens 100 propagate to the retina. The waves from the various diffractive zones (transition zones) mix to create two distinct regions of constructive interference that correspond to the two main foci of the multifocal contact lens 100. In addition, the size of the stepped transitions may be selected (or computed) based on a target energy distribution between the near focus and the distance focus and the width of the stepped transition zones may be selected (or computed) based on a target ADD power of the contact lens.

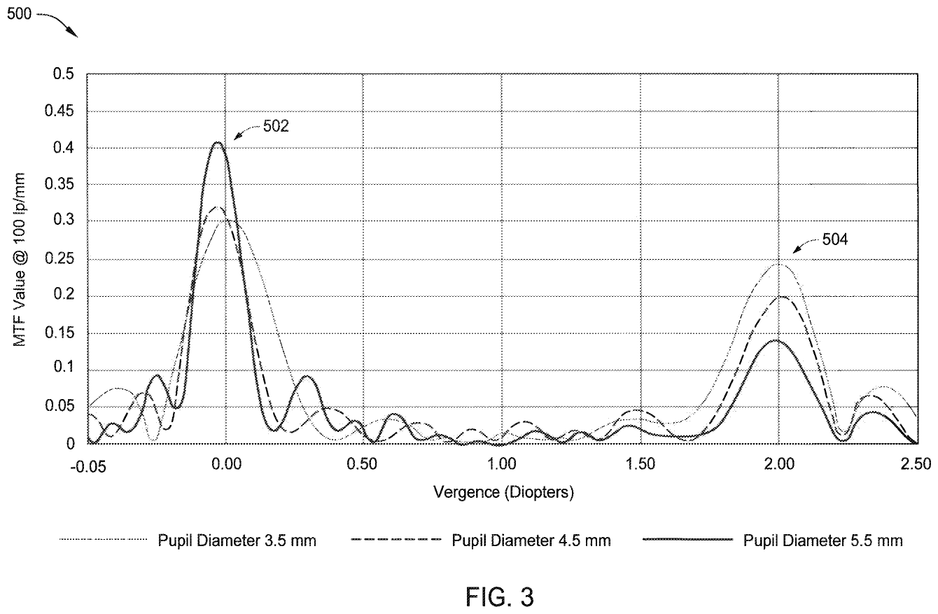

FIG. 3 is a graph 500 depicting example through-focus modulation transfer function (MTF) curves of the example contact lens 100 of FIG. 1A-1B for various pupil diameters and at a spatial frequency of 100 lp/mm, in accordance with certain aspects described herein. As shown, the MTF curves each provide two distinct foci—a first foci 502 at around 0 D with an MTF value of around 0.3 to 0.4 and a second foci 504 at around 2 D with an MTF value of around 0.15 to 0.25.

In some embodiments, the contact lens 100 with the stepped-transition diffractive design may be used in one eye of the wearer, while a different contact lens is used in the other eye of the wearer. For example, a refractive multifocal lens may be worn in the dominant eye, for improved distance vision, while the contact lens 100 with the stepped-transition diffractive design is worn in the non-dominant eye for improved near vision.

It should be noted that while aspects of the disclosure are described with respect to a bifocal design, the smooth surface diffractive design may be used for a multifocal contact lens having more than two foci.

It should also be noted that while aspects of the disclosure are described with respect to a bifocal design for a contact lens, the stepped-transition diffractive design can be used for a diffractive insert which is embedded in a contact lens.

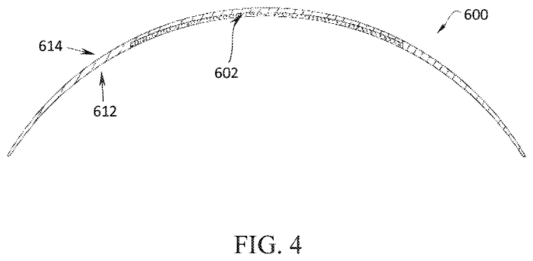

FIG. 4 depicts a side view of the example embedded contact lens 600, in accordance with certain aspects described herein. Embedded contact lens 600 comprises a posterior surface 612, an anterior surface 614, and a circular diffractive insert 602. Circular diffractive insert 602 is concentric with the central axis of the embedded contact lens 600 and comprises a back concave surface and a front convex surface. Back concave surface merges with and becomes an integral part of the posterior surface 612. Front convex surface is buried inside the embedded contact lens 600 and consists of a stepped-transition diffractive surface (not shown).

Although FIG. 4 illustrates example embedded contact lens 600 in which the diffractive insert is partially embedded in a way that its back concave surface merges with and becomes an integral part of the posterior surface of the embedded contact lens, it should be understood that in some embodiments, the diffractive insert may be partially embedded in a way that its front convex surface merges with and becomes an integral part of the anterior surface of the embedded contact lens.

Example System for Designing and Configuring a Contact Lens with a Smooth Surface Diffractive Design

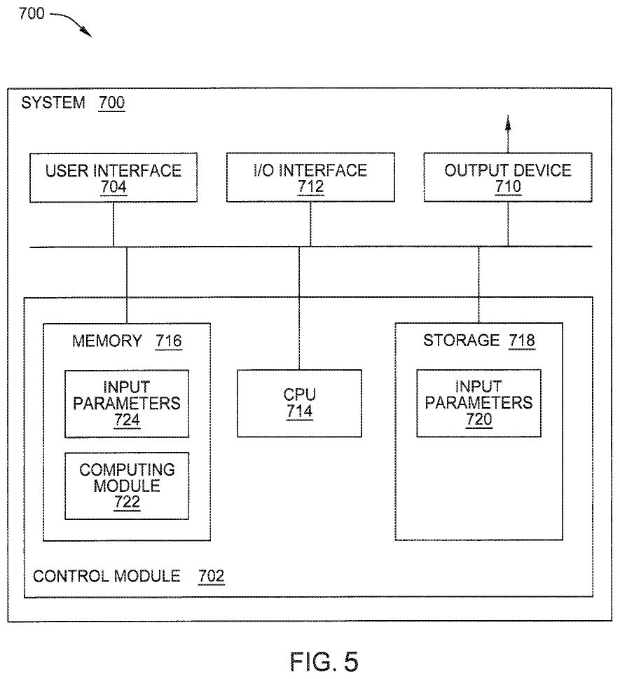

FIG. 5 illustrates an example system 700 for designing, configuring, and/or forming a contact lens 100 with a stepped-transition diffractive design, in accordance with certain aspects described herein.

As shown, system 700 includes, but is not limited to, a control module 702, a user interface display 704, an interconnect 708, an output device 710, and at least one I/O device interface 712, which may allow for the connection of various I/O devices (e.g., keyboards, displays, mouse devices, pen input, etc.) to system 700.

Control module 702 includes a central processing unit (CPU) 714, a memory 716, and a storage 718. CPU 714 may retrieve and execute programming instructions stored in memory 716. Similarly, CPU 714 may retrieve and store application data residing in memory 716. Interconnect 708 transmits data, among CPU 714, I/O device interface 712, user interface display 704, memory 716, storage 718, output device 710, etc. CPU 714 can represent a single CPU, multiple CPUs, a single CPU having multiple processing cores, and the like. Additionally, in certain aspects, memory 716 represents a random access memory. Furthermore, in certain aspects, storage 718 may be a disk drive. Although shown as a single unit, storage 718 may be a combination of fixed or removable storage devices, such as fixed disc drives, removable memory cards or optical storage, network attached storage (NAS), or a storage area-network (SAN).

As shown, storage 718 includes input parameters 720. Input parameters 720 include any of the parameters discuss herein, including the formals described above associated with forming a contact lens with a smooth surface diffractive design. Memory 716 includes a computing module 722 for computing one or more manufacturing parameters discussed herein for forming a contact lens with a smooth surface diffractive design. For example, the manufacturing parameters may include the radius of curvature of the refractive component of the circular diffractive zone; the conic constant of the refractive component of the circular diffractive zone; the polynomial coefficients of the even asphere component (refractive component) of the circular diffractive zone; the maximum semi-diameter of the circular diffractive zone; a design wavelength; an ADD power; an index of refraction of the contact lens material; a maximum number of transition zones; an energy split of a near focus and a distance focus; a transition step height; a transition zone width; a radius of curvature of an annular refractive zone; a conic constant of the annular refractive zone; polynomial coefficients of an even asphere component of the annular refractive zone; and/or a semi-diameter of an optical zone of the contact lens. In addition, memory 716 includes input parameters 724, which may correspond to input parameters 720 or at least a subset thereof. During the computation of the one or more parameters, the input parameters 724 are retrieved from storage 718 and executed in memory 716. In such an example, computing module 722 comprises executable instructions (e.g., including one or more of the formulas described herein) for computing the one or more manufacturing parameters for forming the contact lens with a stepped-transition diffractive design based on the input parameters 724. In certain other aspects, input parameters 724 correspond to parameters received from a user through user interface display 704 or through other methods.

In certain aspects, the computed one or more manufacturing parameters, and in sone embodiments one or more of the input parameters 724, are output via output device 710 to a contact lens manufacturing system that is configured to receive the manufacturing parameters and form a contact lens accordingly. In certain other aspects, system 700 itself is representative of at least a part of a contact lens manufacturing systems. In such aspects, control module 702 then causes hardware components (not shown) of system 700 to form the contact lens according to the manufacturing parameters. The details and operations of a lens manufacturing system are known to one of ordinary skill in the art and are omitted here for brevity.

A circular diffractive zone is designed to have at least one refractive optical element and at least one diffractive optical element. The at least one diffractive optical element comprises a plurality of concentric transition zones around a central axis of the contact lens. The at least one diffractive optical element has a SAG that monotonically changes (e.g., increases) from the center of the contact lens. The circular diffractive zone may be designed based on one or more of the embodiments, including the formulas, described herein. For example, the circular diffractive zone may be formed based on a radius of curvature of the refractive component of the circular diffractive zone; the conic constant of the refractive component of the circular diffractive zone; the polynomial coefficients of the even asphere component of the circular diffractive zone; the maximum semi-diameter of the circular diffractive zone; a design wavelength; an ADD power; an index of refraction of the contact lens material; a maximum number of transition zones; an energy split of a near focus and a distance focus; an transition zone step height; a transition zone width; and/or a semi-diameter of an optical zone of the contact lens.

Forming (designing) the circular diffractive zone may include determining a maximum semi-diameter of the circular diffractive zone (r_{inner_max}), determining a refractive index of the contact lens (N), determining a difference in refractive index between the first and second crosslinked polymeric materials, and determining an OPD of the plurality of concentric transition zones.

Determining the OPD may include determining a plurality of transition step heights (α) for the plurality of concentric transition zones, determining a plurality of transition zone widths (rₙ) for the plurality of concentric transition zones, and determining the OPD based on the plurality of transition step heights and the plurality of transition zone widths for the plurality of concentric transition zones.

Forming (designing) the circular diffractive zone may include determining the plurality of transition zone widths based on an additive (ADD) power of the contact lens and a maximum size of the at least one diffractive optical element.

Forming (designing) the circular diffractive zone may include determining a radius of curvature (Rᵢₙₙₑᵣ) of the refractive optical element of the circular diffractive zone and a conic constant (Kᵢₙₙₑᵣ) of the refractive optical element of the circular diffractive zone based on a target surface profile of the circular diffractive zone.

An annular refractive zone may be designed based on a radius of curvature of the annular refractive zone, a conic constant of the annular refractive zone, polynomial coefficients of an even asphere component of the annular refractive zone, and/or a semi-diameter of an optical zone of the contact lens. Forming (designing) the annular refractive zone may include determining a radius of curvature (Rₒᵤₜₑᵣ) of the annular refractive zone, a conic constant (Kₒᵤₜₑᵣ) of the annular refractive zone, and a height difference (AZ) between a height of the annular refractive zone and a height of the circular diffractive zone based on a target surface profile of the annular refractive zone.

Forming (designing) the circular diffractive zone may include forming the circular diffractive zone on an anterior surface or a posterior surface of the contact lens.

### Example Methods for Manufacturing Multifocal Contact Lenses of the Invention

A multifocal contact lens of the first type can be made according to any techniques known to a person skilled in the art. Without any sawtooth surface, multifocal contact lenses, especially hydrogel multifocal contact lenses, can be manufactured in mass according to the known cast molding techniques. A hydrogel material, e.g., a non-silicone hydrogel material or a silicone hydrogel material, is soft and relatively fragile. The fine and complicate structures of sawtooth-like diffractive design could be damages during opening molds and removing lenses/inserts from mold halves. In contrast, a stepped-transition diffractive structure may have a much higher surviving probability during opening molds and removing lenses/inserts from mold halves.

Contact lenses of the first type can be produced according to a double-side molding process which involves cast-molding of a lens-forming composition, which as known to a person skilled in the art is a polymerizable composition comprising vinylic monomers and vinylic crosslinkers for forming contact lenses), in a mold consisting typically of one male mold half and one female mold half. The female mold half has a molding surface (or a concave molding surface) defining the anterior surface of a multifocal contact lens to be molded whereas the male mold half has a molding surface (or a convex molding surface) defining the posterior surface of the multifocal contact lens to be molded. When the female and male mold halves are mated and closed tightly, a molding cavity is formed between the molding surfaces of the female and male mold halves. One of the two molding surfaces comprises a circular portion defining the circular diffractive zone (as described above) and optionally (but preferably) an annular portion defining the annular refractive zone (as described above). The circular and annular portions are concentric with the central axis of the mold half. A specific quantity of the lens-forming composition is dispensed onto the molding surface of one female mold half, and then the male mold half is pressed onto and closed with the female half to form a molding assembly with the lens-forming composition in the molding cavity. The lens-forming composition within the molding assembly can then be cured actinically by UV/visible lights or thermally in an oven. After the curing step, the molding assembly is opened, and the resultant multifocal contact lens is removed from the mold half to which the resultant multifocal contact lens adheres.

Embedded multifocal contact lenses of the invention can be made according to cast molding processes described in U.S. Pat. Appl. Pub. Nos. US2022/0324187 A1, US2024/0316886 A1, US2023/0339149 A1, US2023/0357478 A1, and US2023/0382065 A1 and U.S. patent application Ser. Nos. 18/678,833, 18/678,872, 63/653,593, 63/653,602, 63/653,611, 63/653,617, 63/653,628, and 63/673,069.

In some embodiments, embedded multifocal contact lenses can be produced according to a method which comprises the steps of (1) obtaining a female lens mold half, a male insert mold half and a male lens mold half, wherein the female lens mold half has a first molding surface defining the anterior surface of an embedded multifocal contact lens to be molded and the front convex surface of a diffractive insert to be molded, wherein the male insert mold half has a second molding surface that defines the back concave surface of the diffractive insert to be molded and comprises a circular or annular portion defining a stepped-transition diffractive surface, wherein the male lens mold half has a third molding surface defining the posterior surface of the embedded multifocal contact lens to be molded, wherein the male insert mold half and the female lens mold half are configured to receive each other such that an insert-molding cavity is formed between the second molding surface and a central portion of the first molding surface when the female lens mold half is closed with the male insert mold half, wherein the male lens mold half and the female lens mold half are configured to receive each other such that a lens-molding cavity is formed between the first and third molding surfaces when the female lens mold half is closed with the male lens mold half; (2) dispensing an amount of an insert-forming composition on the central portion of the first molding surface of the female lens mold half; (3) placing the male insert mold half on top of the insert-forming composition in the female lens mold half and closing the male insert mold half and the female lens mold half to form a first molding assembly comprising the insert-forming composition within the insert-molding cavity; (4) curing the insert-forming composition in the insert-molding cavity of the first molding assembly to form the diffractive insert made of a second crosslinked polymeric material formed from the insert-forming composition and comprising the stepped-transition diffractive surface created on the back concave surface; (5) separating the first molding assembly obtained in step (4) into the male insert mold half and the female lens mold half with the diffractive insert that is adhered onto the central portion of the first molding surface; (6) dispensing a lens-forming composition in the female lens mold half in an amount sufficient for filling the lens-molding cavity; (7) placing the male lens mold half on top of the lens-forming composition in the female lens mold half and closing the male lens mold half and the female lens mold half to form a second molding assembly comprising the lens-forming composition and the diffractive insert immersed therein in the lens-molding cavity; (8) curing the lens-forming composition with the diffractive insert immersed therein in the lens-molding cavity of the second molding assembly to form an embedded multifocal contact lens that comprise a first crosslinked polymeric material (lens bulk material) formed from the lens-forming composition and the diffractive insert embedded partially in the first crosslinked polymeric material; (9) separating the second molding assembly obtained in step (8) into the male lens mold half and the female lens mold half, with the embedded multifocal contact lens adhered on a lens-adhered mold half which is one of the female and male lens mold halves; (10) removing the embedded multifocal contact lens from the lens-adhered lens mold half, and (11) subjecting the embedded multifocal contact lens to post-molding processes including one or more processes selected from the group consisting of extraction, hydration, surface treatment, packaging, sterilization, and combinations thereof.

In some embodiments, embedded multifocal contact lenses can be produced according to a method which comprises the steps of: (1) obtaining a female insert mold half, a male lens mold half and a female lens mold half, wherein the female insert mold half has a fourth molding surface that defines the front convex surface of a diffractive insert to be molded and comprises a circular or annular portion defining a stepped-transition diffractive surface, wherein the male lens mold half has a third molding surface defining the posterior surface of an embedded multifocal contact lens to be molded, wherein the female lens mold half has a first molding surface defining the anterior surface of the embedded multifocal contact lens to be molded, wherein the female insert mold half and the male lens mold half are configured to receive each other such that an insert-molding cavity is formed between the fourth molding surface and a central portion of the third molding surface when the female insert mold half is closed with the male lens mold half, wherein the female lens mold half and the male lens mold half are configured to receive each other such that a lens-molding cavity is formed between the first and third molding surfaces when the second female mold half is closed with the male mold half, (2) dispensing an amount of an insert-forming composition on the central portion of the first molding surface of the female lens mold half, (3) placing the male insert mold half on top of the insert-forming composition in the female lens mold half and closing the male insert mold half and the female lens mold half to form a first molding assembly comprising the insert-forming composition within the insert-molding cavity; (4) curing the insert-forming composition in the insert-molding cavity of the first molding assembly to form the diffractive insert made of a second crosslinked polymeric material formed from the insert-forming composition and comprising the stepped-transition diffractive surface created on the front convex surface; (5) separating the first molding assembly obtained in step (4) into the male insert mold half and the female lens mold half with the diffractive insert that is adhered onto the central portion of the first molding surface; (6) dispensing a lens-forming composition in the female lens mold half in an amount sufficient for filling the lens-molding cavity; (7) placing the male lens mold half on top of the lens-forming composition in the female lens mold half and closing the male lens mold half and the female lens mold half to form a second molding assembly comprising the lens-forming composition and the diffractive insert immersed therein in the lens-molding cavity; (8) curing the lens-forming composition with the diffractive insert immersed therein in the lens-molding cavity of the second molding assembly to form an embedded multifocal contact lens that comprise a first crosslinked polymeric material (lens bulk material) formed from the lens-forming composition and the diffractive insert embedded partially in the first crosslinked polymeric material; (9) separating the second molding assembly obtained in step (8) into the male lens mold half and the female lens mold half, with the embedded multifocal contact lens adhered on a lens-adhered mold half which is one of the female and male lens mold halves; (10) removing the embedded multifocal contact lens from the lens-adhered lens mold half, and (11) subjecting the embedded multifocal contact lens to post-molding processes including one or more processes selected from the group consisting of extraction, hydration, surface treatment, packaging, sterilization, and combinations thereof.

Mold halves for making contact lenses (or inserts) are well known to a person skilled in the art and, for example, are employed in cast molding. In general, a molding assembly comprises at least two mold halves, one male half and one female mold half. The male mold half has a molding (or optical) surface which is in direct contact with a polymerizable composition for cast molding of a contact lens (or an insert) and defines the posterior (back) surface of a molded contact lens (or a molded insert); and the female mold half has a molding (or optical) surface which is in direct contact with the polymerizable composition and defines the anterior (front) surface of the molded contact lens (or molded insert). The male and female mold halves are configured to receive each other such that a lens- or insert-forming cavity is formed between the first molding surface and the second molding surface.

In preferred embodiments, the male insert mold half or the female insert mold half for forming the first molding assembly comprise an overflow groove which surrounds the molding surface and receives any excess insert-forming material when the first molding assembly is closed. By having such an overflow groove, one can ensure that any flushes formed from the excess insert-forming material during molding of the insert can be stuck on the male or female insert mold half during the step of separating the first molding assembly, thereby removing the flushes.

Methods of manufacturing mold halves for cast-molding a contact lens or an insert are generally well known to those of ordinary skill in the art. The process of the present invention is not limited to any particular method of forming a mold half. In fact, any method of forming a mold half can be used in the present invention. The mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making mold halves can be used to make mold halves for making contact lenses or inserts. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used.

An insert-forming composition can be any polymerizable compositions, so long as the crosslinked polymeric materials resulted therefrom have a refractive index that is at least 0.03 higher than the refractive index of the bulk hydrogel material.

In various preferred embodiments, the crosslinked polymeric material of the insert has a refractive index of at least 1.44, (preferably at least 1.46, more preferably at least 1.48, even more preferably at least 1.50), an oxygen permeability of at least 40 barrers (preferably at least 50 barrers, more preferably at least 60 barrers, even more preferably at least 70 barrers), an equilibrium water content of from about 5% to about 45% by weight (preferably from about 10% to about 40% by weight, more preferably from about 10% to about 35%), an elastic modulus of about 7.0 MPa or lower (preferably about 6.0 MPa or lower, more preferably about 5.0 MPa or lower, even more preferably about 4 MPa or lower), or combinations thereof.

In a preferred embodiment, the insert-forming composition is a polymerizable composition for forming a non-silicone hydrogel that is different from the bulk hydrogel material (i.e., the first crosslinked polymeric material) of the embedded multifocal contact lens and comprises one or more high refractive index materials.

In another preferred embodiment, the insert-forming composition is a polymerizable composition for forming a silicone hydrogel that is different from the bulk hydrogel material (i.e., the first crosslinked polymeric material) of the embedded multifocal contact lens and comprises one or more high refractive index materials.

Examples of high refractive index materials include without limitation nanoparticles (e.g., TiO₂, amorphous silicon, PbS, ZnS, etc.), aryl vinylic monomers, aryl vinylic crosslinkers, and combinations thereof.

Examples of preferred aryl vinylic monomers include, but are not limited to: 2-ethylphenoxy acrylate; 2-ethylphenoxy methacrylate; phenyl acrylate; phenyl methacrylate; benzyl acrylate; benzyl methacrylate; 2-phenylethyl acrylate; 2-phenylethyl methacrylate; 3-phenylpropyl acrylate; 3-phenylpropyl methacrylate; 4-phenylbutyl acrylate; 4-phenylbutyl methacrylate; 4-methylphenyl acrylate; 4-methylphenyl methacrylate; 4-methylbenzyl acrylate; 4-methylbenzyl methacrylate; 2-(2-methylphenyl)ethyl acrylate; 2-(2-methylphenyl)ethyl methacrylate; 2-(3-methylphenyl)ethyl acrylate; 2-(3-methylphenyl)ethyl methacrylate; 2-(4-methylphenyl)ethyl acrylate; 2-(4-methylphenyl)ethyl methacrylate; 2-(4-propylphenyl)ethyl acrylate; 2-(4-propylphenyl)ethyl methacrylate; 2-(4-(1-methylethyl)phenyl)ethyl acrylate; 2-(4-(1-methylethyl)phenyl)ethyl methacrylate; 2-(4-methoxyphenyl)ethyl acrylate; 2-(4-methoxy-phenyl)ethyl methacrylate; 2-(4-cyclohexylphenyl)ethyl acrylate; 2-(4-cyclohexylphenyl)ethyl methacrylate; 2-(2-chlorophenyl)ethyl acrylate; 2-(2-chlorophenyl)ethyl methacrylate; 2-(3-chlorophenyl)ethyl acrylate; 2-(3-chlorophenyl)ethyl methacrylate; 2-(4-chlorophenyl)ethyl acrylate; 2-(4-chlorophenyl)ethyl methacrylate; 2-(4-bromophenyl)ethyl acrylate; 2-(4-bromophenyl)ethyl methacrylate; 2-(3-phenylphenyl)ethyl acrylate; 2-(3-phenylphenyl)ethyl methacrylate; 2-(4-phenylphenyl)ethyl acrylate; 2-(4-phenylphenyl)ethyl methacrylate; 2-(4-benzylphenyl)ethyl acrylate; 2-(4-benzylphenyl)ethyl methacrylate; 2-(phenylthio)ethyl acrylate; 2-(phenylthio)ethyl methacrylate; 2-benzyloxyethyl acrylate; 3-benzyloxypropyl acrylate; 2-benzyloxyethyl methacrylate; 3-benzyloxypropyl methacrylate; 2-[2-(benzyloxy)ethoxy]ethyl acrylate; 2-[2-(benzyloxy)ethoxy]ethyl methacrylate; silicone-containing aryl vinylic monomers (e.g., p-vinylphenyltris(trimethylsiloxy)silane, m-vinylphenyltris(trimethylsiloxy)silane, o-vinylphenyltris(trimethylsiloxy)silane, p-styrylethyltris(trimethylsiloxy)silane, m-styrylethyl-tris(trimethylsiloxy)silane, o-styrylethyltris(trimethylsiloxy)silane); aryl-containing ene monomers; or combinations thereof. The above listed aryl acrylic monomers can be obtained from commercial sources or alternatively prepared according to methods known in the art.

Examples of aryl-containing ene monomers include without limitation vinyl naphthalenes, vinyl anthracenes, vinyl phenanthrenes, vinyl pyrenes, vinyl biphenyls, vinyl terphenyls, vinyl phenyl naphthalenes, vinyl phenyl anthracenes, vinyl phenyl phenanthrenes, vinyl phenyl pyrenes, vinyl phenyl terphenyls, phenoxy styrenes, phenyl carbonyl styrenes, phenyl carboxy styrenes, phenoxy carbonyl styrenes, allyl naphthalenes, allyl anthracenes, allyl phenanthrenes, allyl pyrenes, allyl biphenyls, allyl terphenyls, allyl phenyl naphthalenes, allyl phenyl anthracenes, allyl phenyl phenanthrenes, allyl phenyl pyrenes, allyl phenyl terphenyls, allyl phenoxy benzenes, allyl(phenylcarbonyl)benzenes, allyl phenoxy benzenes, allyl(phenyl carbonyl)benzenes, allyl(phenylcarboxy)benzenes, and allyl(phenoxy carbonyl)benzenes.

Examples of preferred aryl-containing ene monomers include without limitation styrene, 2,5-dimethylstyrene, 2-(trifluoromethyl)styrene, 2-chlorostyrene, 3,4-dimethoxystyrene, 3-chlorostyrene, 3-bromostyrene, 3-vinylanisole, 3-methylstyrene, 4-bromostyrene, 4-tert-butylstyrene, 2,3,4,5,6-pentanfluorostyrene, 2,4-dimethylstyrene, 1-methoxy-4-vinylbenzene, 1-chloro-4-vinylbenzene, 1-methyl-4-vinylbenzene, 1-(chloromethyl)-4-vinylbenzene, 1-(bromomethyl)-4-vinylbenzene, 3-nitrostyrene, 1,2-vinyl phenyl benzene, 1,3-vinyl phenyl benzene, 1,4-vinyl phenyl benzene, 4-vinyl-1,1′-(4′-phenyl)biphenylene, 1-vinyl-4-(phenyloxy)benzene, 1-vinyl-3-(phenyloxy)benzene, 1-vinyl-2-(phenyloxy)benzene, 1-vinyl-4-(phenyl carbonyl)benzene, 1-vinyl-3-(phenylcarboxy)benzene, 1-vinyl-2-(phenoxycarbonyl)benzene, allyl phenyl ether, 2-biphenylylallyl ether, allyl 4-phenoxyphenyl ether, allyl 2,4,6-tribromophenyl ether, allyl phenyl carbonate, 1-allyloxy-2-trifluoromethylbenzene, allylbenzene, 1-phenyl-2-prop-2-enylbenzene, 4-phenyl-1-butene, 4-phenyl-1-butene-4-ol, 1-(4-methylphenyl)-3-buten-1-ol, 1-(4-chlorophenyl)-3-buten-1-ol, 4-allyltoluene, 1-allyl-4-fluorobenzene, 1-allyl-2-methylbenzene, 1-allyl-3-methylbenzene, 1-allyl-3-methylbenzene, 2-allylanisole, 4-allylanisole, 1-allyl-4-(trifluromethyl)benzene, allylpentafluorobenzene, 1-allyl-2-methoxybenzene, 4-allyl-1,2-dimethoxybenzene, 2-allylphenol, 2-allyl-6-methylphenol, 4-allyl-2-methoxyphenol, 2-allyloxyanisole, 4-allyl-2-methoxyphenyl acetate, 2-allyl-6-methoxyphenol, 1-allyl-2-bromobezene, alpha-vinylbenzyl alcohol, 1-phenyl-3-butene-1-one, allylbenzyl ether, (3-allyloxy)propyl)benzene, allyl phenylethyl ether, 1-benzyloxy-4-pentene, (1-allyloxy)ethyl)benzene, 1-phenylallyl ethyl ether, (2-methyl-2-(2-propenyloxy)propyl)benzene, ((5-hexenyloxy)methyl)benzene, 1-allyloxy-4-propoxybenzene, 1-phenoxy-4-(3-prop-2-enoxypropoxy)benzene, 6-(4′-Hydroxyphenoxy)-1-Hexene, 4-but-3-enoxyphenol, 1-allyloxy-4-butoxybenzene, 1-allyloxy-4-ethoxybenzene, 1-allyl-4-benzyloxybenzene, 1-allyl-4-(phenoxy)benzene, 1-allyl-3-(phenoxy)benzene, 1-allyl-2-(phenoxy)benzene, 1-allyl-4-(phenyl carbonyl)benzene, 1-allyl-3-(phenyl carboxy)benzene, 1-allyl-2-(phenoxycarbonyl)benzene, 1,2-allyl phenyl benzene, 1,3-allyl phenyl benzene, 1,4-allyl phenyl benzene, 4-vinyl-1,1′-(4′-phenyl)biphenylene, 1-allyl-4-(phenyloxy)benzene, 1-allyl-3-(phenyloxy)benzene, 1-allyl-2-(phenyloxy)benzene, 1-allyl-4-(phenyl carbonyl)benzene, 1-allyl-3-(phenyl carboxy)benzene, and 1-allyl-2-(phenoxycarbonyl)benzene, 1-vinyl naphthylene, 2-vinyl naphthylene, 1-allyl naphthalene, 2-allyl naphthalene, allyl-2-naphthyl ether, 2-(2-methylprop-2-enyl)naphthalene, 2-prop-2-enylnaphthalene, 4-(2-naphthyl)-1-butene, 1-(3-butenyl)naphthalene, 1-allyl naphthalene, 2-allyl naphthalene, 1-allyl-4-napthyl naphthalene, 2-(allyloxy)-1-bromonaphthalene, 2-bromo-6-allyloxynaphthalene, 1,2-vinyl(1-naphthyl)benzene, 1,2-vinyl(2-naphthyl)benzene, 1,3-vinyl(1-naphthyl)benzene, 1,3-vinyl(2-naphthyl)benzene, 1,4-vinyl(1-naphthyl)benzene, 1,4-vinyl(2-naphthyl)benzene, 1-naphthyl-4-vinyl naphthalene, 1-allyl naphthalene, 2-allyl naphthalene, 1,2-allyl(1-naphthyl) benzene, 1,2-allyl(2-naphthyl)benzene, 1,3-allyl(1-naphthyl)benzene, 1,3-allyl(2-naphthyl)benzene, 1,4-allyl(1-naphthyl)benzene, 1,4-allyl(2-naphthyl)benzene, 1-allyl-4-napthyl naphthalene, 1-vinyl anthracene, 2-vinyl anthracene, 9-vinyl anthracene, 1-allyl anthracene, 2-allyl anthracene, 9-allyl anthracene, 9-pent-4-enylanthracene, 9-allyl-1,2,3,4-tetrachloroanthracene, 1-vinyl phenanthrene, 2-vinyl phenanthrene, 3-vinyl phenanthrene, 4-vinyl phenanthrene, 9-vinyl phenanthrene, 1-allyl phenanthrene, 2-allyl phenanthrene, 3-allyl phenanthrene, 4-allyl phenanthrene, 9-allyl phenanthrene, and combinations thereof.

Preferred aryl vinylic monomers are 2-phenylethyl acrylate; 3-phenylpropyl acrylate; 4-phenylbutyl acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; p-vinylphenyl-tris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethylsiloxy) silane; o-styrylethyltris(trimethylsiloxy)silane; or combinations thereof. Most preferred are p-vinylphenyltris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethylsiloxy) silane; o-styrylethyltris(trimethylsiloxy)silane; or combinations thereof.

Any aryl vinylic crosslinkers can be used. Examples of aryl vinylic crosslinkers include without limitation non-silicone aryl vinylic crosslinkers (e.g., divinylbenzene, 2-methyl-1,4-divinylbenzene, bis(4-vinylphenyl)methane, 1,2-bis(4-vinylphenyl)ethane, etc.), silicone-containing aryl vinylic crosslinkers.

Preferred silicone-containing aryl vinylic crosslinkers are aryl-containing polysiloxane vinylic crosslinkers each of which comprises: (1) a polydiorganosiloxane segment comprising dimethylsiloxane units and aryl-containing siloxane units each having at least one aryl-containing substituent having up to 45 carbon atoms; and (2) ethylenically-unsaturated groups (preferably (meth)acryloyl groups). In a preferred embodiment, the polydiorganosiloxane segment comprises at least 25% by mole of the aryl-containing siloxane units. The preferred aryl-containing polysiloxane vinylic crosslinkers can have a number average molecular weight of at least 1000 Daltons (preferably from 1500 Daltons to 100000 Daltons, more preferably from 2000 to 80000 Daltons, even more preferably from 2500 to 60000 Dalton).

Examples of such preferred aryl-containing polysiloxane vinylic crosslinkers include without limitation vinyl terminated polyphenylmethysiloxanes (e.g., PMV9925 from Gelest), vinylphenylmethyl terminated phenylmethyl-vinylphenylsiloxane copolymer (e.g., PVV-3522 from Gelest), vinyl terminated diphenylsiloxane-dimethylsiloxane copolymers (e.g., PDV-1625 from Gelest), (meth)acryloxyalkyl-terminated polyphenylmethysiloxanes, (meth)acryloxyalkyl-terminated phenylmethyl-vinylphenylsiloxane copolymers, (meth)acryloxyalkyl-terminated diphenylsiloxane-dimethylsiloxane copolymers, ethylenically-unsaturated group-terminated dimethylsiloxane-arylmethylsiloxane copolymers disclosed in U.S. Pat. Appl. Pub. No. 2022/00306810, or combinations thereof.

A lens-forming composition is any polymerizable compositions suitable for making non-silicone hydrogel materials (i.e., non-silicone hydrogel lens-forming compositions) or preferably silicone hydrogel (SiHy) materials (i.e., silicone hydrogel lens-forming compositions).

A non-silicone hydrogel lens-forming composition is either (1) a monomeric reaction composition comprising (a) at least one hydrophilic vinylic monomer (e.g., hydroxyl-containing vinylic monomer, N-vinylpyrrolidone, or combinations thereof) and (b) at least one component selected from the group consisting of a vinylic crosslinker, a hydrophobic vinylic monomer, a free-radical initiator (photoinitiator or thermal initiator), a UV-absorbing vinylic monomer, a high-energy-violet-light (“HEVL”) absorbing vinylic monomer, a visibility tinting agent, and combinations thereof, or (2) an aqueous solution comprising one or more water-soluble prepolymers and at least one component selected from the group consisting of hydrophilic vinylic monomer, a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a HEVL absorbing vinylic monomer, a visibility tinting agent, and combinations thereof.

Examples of water-soluble prepolymers include without limitation: a water-soluble crosslinkable poly(vinyl alcohol) prepolymer described in U.S. Pat. Nos. 5,583,163 and 6,303,687; a water-soluble vinyl group-terminated polyurethane prepolymer described in U.S. Pat. No. 6,995,192; derivatives of a polyvinyl alcohol, polyethyleneimine or polyvinylamine, which are disclosed in U.S. Pat. No. 5,849,841; a water-soluble crosslinkable polyurea prepolymer described in U.S. Pat. Nos. 6,479,587 and 7,977,430; crosslinkable polyacrylamide; crosslinkable statistical copolymers of vinyl lactam, MMA and a comonomer, which are disclosed in U.S. Pat. No. 5,712,356; crosslinkable copolymers of vinyl lactam, vinyl acetate and vinyl alcohol, which are disclosed in U.S. Pat. No. 5,665,840; polyether-polyester copolymers with crosslinkable side chains which are disclosed in U.S. Pat. No. 6,492,478; branched polyalkylene glycol-urethane prepolymers disclosed in U.S. Pat. No. 6,165,408; polyalkylene glycol-tetra(meth)acrylate prepolymers disclosed in U.S. Pat. No. 6,221,303; crosslinkable polyallylamine gluconolactone prepolymers disclosed in U.S. Pat. No. 6,472,489.

Numerous non-silicone hydrogel lens-forming compositions have been described in numerous patents and patent applications published by the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A. They can be used as a lens-forming composition.

Numerous SiHy lens-forming compositions have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. They can be used as a lens-forming composition.

Preferably, a SiHy lens-forming composition comprises (a) at least one silicone-containing vinylic monomer and/or at least one polysiloxane vinylic crosslinker, (b) at least one hydrophilic vinylic monomer, (c) at least one free-radical initiator, (d) at least one component selected from the group consisting of at least one non-silicone vinylic crosslinker, at least one UV-absorbing vinylic monomer, at least one HEVL-absorbing vinylic monomer, a visibility tinting agent, and combinations thereof.

Examples of preferred silicone-containing vinylic monomers include without limitation vinylic monomers each having a bis(trialkylsilyloxy)alkylsilyl group (preferably a bis(trimethylsilyloxy)-alkylsilyl group) or a tris(trialkylsilyloxy)silyl group (preferably a tris(trimethylsilyloxy)silyl group), polysiloxane vinylic monomers, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

Examples of preferred silicone-containing vinylic monomers each having a bis(trialkylsilyloxy)alkylsilyl group or a tris(trialkylsilyloxy)silyl group include without limitation tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propylbis(trimethyl-siloxy)butylsilane, 3-(meth)acryloxy-2-(2-hydroxyethoxy)-propyloxy)propyl-bis(trimethylsiloxy)-methylsilane, 3-(meth)acryloxy-2-hydroxypropyloxy)propyltris(trimethylsiloxy) silane, N-[tris(trimethylsiloxy)silylpropyl]-(meth)acrylamide, N-(2-hydroxy-3-(3-(bis(trimethylsilyloxy)-methylsilyl)propyloxy)-propyl)-2-methyl (meth)acrylamide, N-(2-hydroxy-3-(3-(bis(trimethyl-silyloxy)methylsilyl)propyloxy)propyl) (meth)acrylamide, N-(2-hydroxy-3-(3-(tris(trimethyl-silyloxy)silyl)propyloxy)-propyl)-2-methyl acrylamide, N-(2-hydroxy-3-(3-(tris(trimethylsilyloxy)-silyl)propyloxy)propyl) (meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethyl-ethylsiloxy)silylpropyl](meth)acrylamide, N,N-bis[2-hydroxy-3-(3-(bis(trimethylsilyloxy)-methylsilyl)propyloxy)propyl]-2-methyl (meth)acrylamide, N,N-bis[2-hydroxy-3-(3-(bis(trimethyl-silyloxy)methylsilyl)propyloxy)-propyl](meth)acrylamide, N,N-bis[2-hydroxy-3-(3-(tris(trimethyl-silyloxy)silyl)propyloxy)propyl]-2-methyl (meth)acrylamide, N,N-bis[2-hydroxy-3-(3-(tris(trimethyl-silyloxy)silyl)propyloxy)propyl](meth)acrylamide, N-[2-hydroxy-3-(3-(t-butyldimethylsilyl)-propyloxy)propyl]-2-methyl (meth)acrylamide, N-[2-hydroxy-3-(3-(t-butyldimethylsilyl)propyloxy)-propyl](meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl]propyl allyl carbamate, 3-[tris(trimethylsiloxy)silyl]propyl vinyl carbonate, those disclosed in U.S. Pat. Nos. 9,097,840, 9,103,965 and 9,475,827 (herein incorporated by references in their entireties), and mixtures thereof. The above preferred silicone-containing vinylic monomers can be obtained from commercial suppliers or can be prepared according to procedures described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827.

Examples of preferred polysiloxane vinylic monomers include without limitation mono-(meth)acryloyl-terminated, monoalkyl-terminated polysiloxanes include without limitation α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxy-propyl]-terminated ω-butyl (or ω-methyl) polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl]terminated ω-butyl (or ω-methyl) polydimethylsiloxane, α-[3-[N-methyl-(meth)acryloylamido]-2-hydroxypropyloxy-propyl]terminated ω-butyl (or ω-methyl) terminated polydimethylsiloxane, N-methyl-N′-(propyl-tetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above preferred polysiloxanes vinylic monomers can be obtained from commercial suppliers (e.g., Shin-Etsu, Gelest, etc.) or prepared according to procedures described in patents, e.g., U.S. Pat. Nos. 6,166,236, 6,867,245, 8,415,405, 8,475,529, 8,614,261, 9,217,813, and 9,315,669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl (meth)acrylate with a mono-carbinol-terminated polydimethylsiloxane according to coupling reactions well known to a person skilled in the art.

Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with diamino-terminated polysiloxanes; the reaction products of glycidyl methacrylate with dihydroxyl-terminated polysiloxanes; the reaction products of an azlactone-containing vinylic monomer (any one of those described above) with di-hydroxyl-terminated polydimethylsiloxanes; the reaction products of isocyantoethyl (meth)acrylate with di-hydroxyl-terminated polydimethylsiloxanes; the reaction products of isocyantoethyl (meth)acrylate with diamino-terminated polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047.

One class of preferred polysiloxane vinylic crosslinkers are vinylic crosslinkers which are prepared by: reacting glycidyl (meth)acrylate or (meth)acryloyl chloride with a di-amino-terminated polydimethylsiloxane or a di-hydroxyl-terminated polydimethylsiloxane; reacting isocyantoethyl (meth)acrylate with di-hydroxyl-terminated polydimethylsiloxanes; reacting an amino-containing acrylic monomer with di-carboxyl-terminated polydimethylsiloxane in the presence of a coupling agent (a carbodiimide); reacting a carboxyl-containing acrylic monomer with di-amino-terminated polydimethylsiloxane in the presence of a coupling agent (a carbodiimide); or reacting a hydroxyl-containing acrylic monomer with a di-hydroxy-terminated polydisiloxane in the presence of a diisocyanate or di-epoxy coupling agent.

Examples of such preferred polysiloxane vinylic crosslinkers are α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxy-propyl]-terminated polydimethylsiloxane, α,ω-bis[3-(meth)acryloxybutyloxy-2-hydroxypropyloxy-propyl]-terminated polydimethylsiloxane, α,ω-bis[3-(meth)acrylamidoethoxy-2-hydroxypropyloxy-propyl]-terminated polydimethylsiloxane, α,ω-bis[3-(meth)acrylamidopropyloxy-2-hydroxy-propyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethyl-amino-2-hydroxypropyloxypropyl]-terminated polydimethylsiloxane, α,ω-bis[3-(meth)acryloxy-propylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, and combinations thereof.

Another class of preferred polysiloxane vinylic crosslinkers are chain-extended polysiloxane vinylic crosslinkers each of which comprises at least two polysiloxane segments and can be prepared according to the procedures described in U.S. Pat. Nos. 5,034,461, 5,416,132, 5,449,729, 5,760,100, 7,423,074, 8,529,057, 8,835,525, 8,993,651, and 10301451 and in U.S. Pat. App. Pub. No. 2018-0100038 A1.

A further class of preferred polysiloxane vinylic crosslinkers are hydrophilized polysiloxane vinylic crosslinkers that each comprise at least about 1.50 (preferably at least about 2.0, more preferably at least about 2.5, even more preferably at least about 3.0) milliequivalent/gram (“meq/g”) of hydrophilic moieties, which preferably are hydroxyl groups (—OH), carboxyl groups (—COOH), amino groups (—NHR_{N1} in which R_{N1} is H or C₁-C₂ alkyl), amide moieties (—CO—NR_{N1}R_{N2} in which R_{N1} is H or C₁-C₂ alkyl and R_{N2} is a covalent bond, H, or C₁-C₂ alkyl), N—C₁-C₃ acylamino groups, urethane moieties (—NH—CO—O—), urea moieties (—NH—CO—NH—), a polyethylene glycol chain of

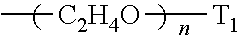

in which n is an integer of 2 to 20 and T₁ is H, methyl or acetyl or a phosphorylcholin group, or combinations thereof. U.S. Pat. No. 10,081,697 and U.S. Pat. Appl. Pub. No. 2022/0251302 A1 disclose hydrophilized polysiloxane vinylic crosslinkers which each comprise (1) a polydiorganosiloxane polymer chain comprising dimethylsiloxane units and hydrophilized siloxane unit having one methyl substituent and one hydrophilized organic substituent having two to six hydroxyl groups or phosphorylcholine moiety.

Any hydrophilic vinylic monomers can be used in the invention. Examples of preferred hydrophilic vinylic monomers are alkyl (meth)acrylamides (as described later in this application), hydroxyl-containing acrylic monomers (as described below), amino-containing acrylic monomers (as described later in this application), carboxyl-containing acrylic monomers (as described later in this application), N-vinyl amide monomers (as described later in this application), methylene-containing pyrrolidone monomers (i.e., pyrrolidone derivatives each having a methylene group connected to the pyrrolidone ring at 3- or 5-position) (as described later in this application), acrylic monomers having a C₁-C₄ alkoxyethoxy group (as described later in this application), vinyl ether monomers (as described later in this application), allyl ether monomers (as described later in this application), phosphorylcholine-containing vinylic monomers (as described later in this application), N-2-hydroxyethyl vinyl carbamate, N-carboxyvinyl-β-alanine (VINAL), N-carboxyvinyl-α-alanine, and combinations thereof.

Examples of alkyl (meth)acrylamides include without limitation (meth)acrylamide, N,N-dimethyl (meth)acrylamide, N-methyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof.

Examples of hydroxyl-containing acrylic monomers include without limitation N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof.

Examples of carboxyl-containing acrylic monomers include without limitation 2-(meth)acrylamidoglycolic acid, (meth)acrylic acid, ethylacrylic acid, 3-(meth)acrylamido-propionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(emth)acrylamido-2methyl-3,3-dimethyl butanoic acid, 3-(meth)acrylamidohaxanoic acid, 4-(meth)acrylamido-3,3-dimethylhexanoic acid, and combinations thereof.

Examples of amino-containing acrylic monomers include without limitation N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof.

Examples of N-vinyl amide monomers include without limitation N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof.

Examples of methylene-containing pyrrolidone monomers include without limitation 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and mixtures thereof.

Examples of acrylic monomers having a C₁-C₄ alkoxyethoxy group include without limitation ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof.

Examples of vinyl ether monomers include without limitation ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof.

Examples of allyl ether monomers include without limitation ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof.

Examples of phosphorylcholine-containing vinylic monomers include without limitation (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]-propyl-2′-(trimethylammonio)-ethylphosphate, 4-[(meth)acryloylamino]butyl-2′-(trimethyl-ammonio)ethylphosphate, 5-((meth)acryloyloxy)pentyl-2′-(trimethylammonio)ethyl phosphate, 6-((meth)acryloyloxy)hexyl-2′-(trimethylammonio)-ethylphosphate, 2-((meth)acryloyloxy)ethyl-2′-(triethylammonio)ethyl-phosphate, 2-((meth)acryloyloxy)ethyl-2′-(tripropylammonio)ethylphosphate, 2-((meth)acryloxy)-ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)ethyl-phosphate, 2-(vinylcarbonyl-amino)ethyl-2′-(trimethylammonio)ethylphosphate, 2-(allyloxycarbonylamino)-ethyl-2′-(trimethylammonio)ethyl phosphate, 2-(butenoyloxy)ethyl-2′-(trimethylammonio)-ethylphosphate, and combinations thereof.

In accordance with the invention, the SiHy lens-forming composition can also comprise one or more hydrophobic non-silicone vinylic monomers. Examples of preferred hydrophobic non-silicone vinylic monomers can be non-silicone hydrophobic acrylic monomers (methyl (meth)acrylate, ethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), fluorine-containing acrylic monomers (e.g., perfluorohexylethyl-thio-carbonyl-aminoethyl-methacrylate, perfluoro-substituted-C₂-C₁₂ alkyl (meth)acrylates described below, etc.), vinyl alkanoates (e.g., vinyl acetate, vinyl propionate, vinyl butyrate, vinyl valerate, etc.), vinyloxyalkanes (e.g., vinyl ethyl ether, propyl vinyl ether, n-butyl vinyl ether, isobutyl vinyl ether, cyclohexyl vinyl ether, t-butyl vinyl ether, etc.), styrene, vinyl toluene, vinyl chloride, vinylidene chloride, 1-butene, and combinations thereof.

Any suitable perfluoro-substituted-C₂-C₁₂ alkyl (meth)acrylates can be used in the invention. Examples of perfluoro-substituted-C₂-C₁₂ alkyl (meth)acrylates include without limitation 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, and combinations thereof.

In accordance with the invention, the SiHy lens-forming composition can also comprise one or more non-silicone vinylic crosslinkers (free of aryl group). Examples of preferred non-silicone vinylic cross-linking agents include without limitation: acrylic crosslinkers (free of aryl group) as described above, allyl methacrylate, allyl acrylate, N-allyl-methacrylamide, N-allyl-acrylamide, tetraethyleneglycol divinyl ether, triethyleneglycol divinyl ether, diethyleneglycol divinyl ether, ethyleneglycol divinyl ether, triallyl isocyanurate, 2,4,6-triallyloxy-1,3,5-triazine, 1,2,4-trivinylcyclohexane, or combinations thereof.

In accordance with the invention, the SiHy lens-forming composition can also comprises other polymerizable materials, such as, a UV-absorbing vinylic monomer, a UV/high-energy-violet-light (“HEVL”) absorbing vinylic monomer, a polymerizable tinting agent (polymerizable dye), or combinations thereof, as known to a person skilled in the art.

Any suitable UV-absorbing vinylic monomers and UV/HEVL-absorbing vinylic monomers can be used in a polymerizable composition for preparing a preformed SiHy contact lens of the invention. Examples of preferred UV-absorbing and UV/HEVL-absorbing vinylic monomers include without limitation: 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxypropylphenyl) benzotriazole, 2-hydroxy-5-methoxy-3-(5-(trifluoromethyl)-2H-benzo[d][1,2,3]triazol-2-yl)benzyl methacrylate (WL-1), 2-hydroxy-5-methoxy-3-(5-methoxy-2H-benzo[d][1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3]triazol-2-yl)-2-hydroxy-5-methoxybenzyl methacrylate (WL-4), 2-hydroxy-5-methoxy-3-(5-methyl-2H-benzo[d][1,2,3]triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]triazol-2-yl)-6-methoxyphenol (WL-8), 2-{2′-Hydroxy-3′-tert-5′[3″-(4″-vinylbenzyloxy)propoxy]phenyl}-5-methoxy-2H-benzotriazole, phenol, 2-(5-chloro-2H-benzotriazol-2-yl)-6-(1,1-dimethylethyl)-4-ethenyl-(UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy)phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3]triazol-2-yl)phenoxy)ethyl methacrylate (16-102); Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)propyl]-3-tert-butylphenyl]-5-chloro-2H-benzotriazole; Phenol, 2-(5-ethenyl-2H-benzotriazol-2-yl)-4-methyl-, homopolymer (9CI) (CAS #83063-87-0). In accordance with the invention, the polymerizable composition comprises about 0.1% to about 3.0%, preferably about 0.2% to about 2.5%, more preferably about 0.3% to about 2.0%, by weight of one or more UV-absorbing vinylic monomers, related to the amount of all polymerizable components in the polymerizable composition.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates free radical crosslinking/polymerizing reaction by the use of heat energy.

Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydroperoxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173® and Darocur 2959®, Germanium-based Norrish Type I photoinitiators (e.g., those described in U.S. Pat. No. 7,605,190). Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide.

A lens-forming composition or an insert-forming composition can be a solventless liquid prepared by mixing all polymerizable components (or materials) and other necessary component (or materials) or a solution prepared by dissolving all of the desirable components (or materials) in any suitable solvent, such as, a mixture of water and one or more organic solvents miscible with water, an organic solvent, or a mixture of one or more organic solvents, as known to a person skilled in the art. The term “solvent” refers to a chemical that cannot participate in free-radical polymerization reaction (any of those solvents as described later in this application).

A solventless polymerizable composition for forming silicone hydrogel (SiHy) materials typically comprises at least one blending vinylic monomer as a reactive solvent for dissolving all other polymerizable components. Examples of preferred blending vinylic monomers are described later in this application. Preferably, methyl methacrylate is used as a blending vinylic monomer in preparing a solventless polymerizable composition.

Examples of suitable solvents include acetone, methanol, cyclohexane, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. More preferred organic solvents include without limitation methanol, ethanol, 1-propanol, isopropanol, sec-butanol, tert-butyl alcohol, tert-amyl alcohol, acetone, methyl ethyl ketone, methyl isopropyl ketone, methyl propyl ketone, ethyl acetate, heptane, methylhexane (various isomers), methylcyclohexane, dimethylcyclopentane (various isomers), 2,2,4-trimethylpentane, and mixtures thereof.

The lens-forming composition and the insert-forming composition can be introduced into the mold half according to any techniques known to a person skilled in the art.

The curing of the lens-forming composition or the insert-forming composition within the molding cavity of the molding assembly can be carried out thermally (i.e., by heating) or actinically (i.e., by actinic radiation, e.g., UV radiation and/or visible radiation) to activate the free-radical initiators.

The actinic polymerization of the lens-forming composition or the insert-forming composition in a molding assembly can be carried out by irradiating the closed molding assembly with the lens formulation therein with an UV or visible light, according to any techniques known to a person skilled in the art.

The thermal polymerization of the lens-forming composition or the insert-forming composition in a molding assembly can be carried out conveniently in an oven at a temperature of from 25 to 120° C. and preferably 40 to 100° C., as well known to a person skilled in the art. The reaction time may vary within wide limits, but is convenient, for example, from 1 to 24 hours or preferably from 2 to 12 hours. It is advantageous to previously degas the silicone-hydrogel-lens-forming composition and to carry out said copolymerization reaction under an inert atmosphere, e.g., under N₂ or Ar atmosphere.

The step of separating molding assemblies can be carried out according to any techniques known to a person skilled in the art.

The multifocal contact lens can be delensed (i.e., removed) from the lens-adhered mold half according to any techniques known to a person skilled in the art.

After the multifocal contact lens is delensed, it typically is extracted with an extraction medium as well known to a person skilled in the art. The extraction liquid medium is any solvent capable of dissolving the diluent(s), unpolymerized polymerizable materials, and oligomers in the embedded SiHy contact lens precursor. Water, any organic solvents known to a person skilled in the art, or a mixture thereof can be used in the invention. Preferably, the organic solvents used extraction liquid medium are water, a buffered saline, a C₁-C₃ alkyl alcohol, 1,2-propylene glycol, a polyethyleneglycol having a number average molecular weight of about 400 Daltons or less, a C₁-C₆ alkylalcohol, or combinations thereof.

The extracted multifocal contact lens can then be hydrated according to any method known to a person skilled in the art.

The hydrated multifocal contact lens can further subject to further processes, such as, for example, surface treatment, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part or can be combined in any manner and/or used together, as illustrated below:
1. A multifocal contact lens, comprising:
   an anterior surface having a first optical zone; an opposite posterior surface having a second optical zone; and a central axis,
   wherein the first and second optical zones are circular and concentric with the central axis and have a diameter of from about 5.0 mm to about 11.0 mm (preferably from about 6.0 mm to about 10.5 mm, more preferably from about 6.5 mm to 10.0 mm, even more preferably from about 7.0 mm to about 9.5 mm), wherein at least one of the first and second optical zones comprises a circular diffractive zone and optionally an annular refractive zone surrounding the circular diffractive zone, wherein both the annular refractive zone and the circular diffractive zone are concentric with the central axis, wherein the circular diffractive zone has a monotonically increasing surface sagitta (SAG) profile in a direction radiating from the central axis and comprises a circular stepped-transition diffractive surface that provides at least one first refractive optical power for a first distant focus and at least one diffractive optical power which is an ADD power needed for a near focus, wherein the annular refractive zone has a surface profile that provide a second refractive optical power for a second distant focus, wherein the circular diffractive zone has a diameter of from about 2.0 mm to about 7.5 mm (preferably from about 2.5 mm to about 7.0 mm, more preferably from about 3.0 mm to about 6.5 mm, even more preferably from about 3.5 mm to about 6.0 mm)
2. The multifocal contact lens of embodiment 1, wherein the circular diffractive zone is on the anterior surface of the multifocal contact lens.
3. The multifocal contact lens of embodiment 1, wherein the circular diffractive zone is on the posterior surface of the multifocal contact lens.
4. The multifocal contact lens of any one of embodiments 1 to 3, wherein the multifocal contact lens is made of a first non-silicone hydrogel material.
5. The multifocal contact lens of any one of embodiments 1 to 3, wherein the multifocal contact lens is made of a first silicone hydrogel material.
6. The multifocal contact lens of any one of embodiments 1 to 3, wherein the multifocal contact lens is made of a first rigid gas permeable material.
7. A multifocal contact lens, comprising:
   an anterior surface; an opposite posterior surface; a central axis; a first crosslinked polymeric material that constitutes at least 60% by weight of the multifocal diffractive contact lens in dry state and has a first refractive index; and a circular or annular diffractive insert that is made of a second crosslinked polymeric material having a second refractive index and that is concentric with the central axis and embedded completely or partially in the first crosslinked polymeric material,
   wherein the second refractive index is at least 0.03 (preferably at least 0.04, more preferably at least 0.05, even more preferably 0.07) higher than the first refractive index,
   wherein the circular or annular diffractive insert comprises a front convex surface and an opposite back concave surface, wherein at least one of the front convex and back concave surfaces is buried inside the multifocal contact lens and directly in contact with the first crosslinked polymeric material and is designated as a buried surface of the circular or annular diffractive insert, wherein the buried surface of the circular or annular diffractive insert has a monotonically increasing surface sagitta (SAG) profile in a direction radiating from the central axis, wherein the circular diffractive insert has a diameter of from about 2.0 mm to about 7.5 mm (preferably from about 2.5 mm to about 7.0 mm, more preferably from about 3.0 mm to about 6.5 mm, even more preferably from about 3.5 mm to about 6.0 mm) and comprises a circular stepped-transition diffractive surface on the buried surface, wherein the annular diffractive insert has an inner diameter of from about 0.5 mm to about 3.0 mm (preferably from about 0.5 mm to about 2.5 mm, more preferably from about 0.5 mm to 2.0 mm, even more preferably from about 0.5 mm to about 1.5 mm) and an outer diameter of about 7.5 mm or less (preferably about 7.0 mm or less, more preferably from about 6.5 mm or less, even more preferably from about 6.0 mm or less) and comprises an annular stepped-transition diffractive surface on the buried surface, wherein the circular or annular stepped-transition diffractive surface provides at least one first refractive optical power for a distant focus and at least one diffractive optical power which is an ADD power needed for a near focus.
8. The multifocal contact lens of embodiment 7, wherein the front convex surface of the circular or annular diffractive insert merges with and is integral part of the anterior surface of the multifocal contact lens, wherein the circular or annular stepped-transition diffractive surface is on the back concave surface of the circular or annular diffractive insert.
9. The multifocal contact lens of embodiment 7, wherein the back concave surface of the circular or annular diffractive insert merges with and is integral part of the posterior surface of the multifocal contact lens, wherein the circular or annular stepped-transition diffractive surface is on the front convex surface of the circular or annular diffractive insert.
10. The multifocal contact lens of any one of embodiments 7 to 9, wherein the first crosslinked polymeric material is a first non-silicone hydrogel material.
11. The multifocal contact lens of any one of embodiments 7 to 9, wherein the first crosslinked polymeric material is a first silicone hydrogel material.
12. The multifocal contact lens of any one of embodiments 7 to 11, wherein the second crosslinked polymeric material is a second non-silicone hydrogel material.
13. The multifocal contact lens of any one of embodiments 7 to 11, wherein the second crosslinked polymeric material is a second silicone hydrogel material.
14. The multifocal contact lens of any one of embodiments 7 to 11, wherein the second crosslinked polymeric material is a second rigid gas permeable material.
15. The multifocal contact lens of any one of embodiments 7 to 14, wherein the multifocal contact lens comprises the circular diffractive insert.
16. The multifocal contact lens of any one of embodiments 7 to 14, wherein the multifocal contact lens comprises the annular diffractive insert.
17. The multifocal contact lens of embodiment 16, wherein the annular stepped-transition diffractive surface comprises a plurality of annular curved surface zones and a plurality of annular transition zones, wherein the plurality of the annular curved surface zone and the plurality of the annular transition zones all are concentric with the central axis, wherein each of the plurality of the annular transition zones creates one sharp change in SAG between two adjoining annular curved surface zones, wherein the annular transition zones optically function to provide diffractive optical properties whereas the circular curved central surface zone and the annular curved surface zones provide refractive optical properties.
18. The multifocal contact lens of any one of embodiments 1 to 15, wherein the circular stepped-transition diffractive surface comprises one circular curved central surface zone, a plurality of annular curved surface zones, and a plurality of annular transition zones, wherein the circular curved central surface zone, the plurality of the annular curved surface zone and the plurality of the annular transition zones all are concentric with the central axis, wherein each of the plurality of the annular transition zones creates one sharp change in SAG between the circular curved central surface zone and nearest annular curved surface zone or between two adjoining annular curved surface zones, wherein the annular transition zones optically function to provide diffractive optical properties whereas the circular curved central surface zone and the annular curved surface zones provide refractive optical properties.
19. The multifocal contact lens of any one of embodiments 1 to 18, wherein the circular curved central surface zone and the annular curved surface zones are spherical or aspherical surfaces.
20. Th multifocal contact lens of embodiment 19, wherein the curvatures of the circular curved surface zone and the annular curved surface zones are substantially identical to each other.
21. Th multifocal contact lens of embodiment 19, wherein the curvatures of the circular curved surface zone and the annular curved surface zones are different from each other.
22. The multifocal contact lens of any one of embodiments 1 to 21, wherein the annular transition surface zones independent of one another have a width of about 0.1 mm or less (preferably about 0.08 mm or less, more preferably about 0.06 mm or less, even more preferably about 0.05 mm or less).
23. The multifocal contact lens of any one of embodiments 1 to 21, wherein the circular or annular stepped-transition diffractive surface comprise at least 3 annular transition surface zones (preferably from 5 to 10 annular transition surface zones).
24. The multifocal contact lens of any one of embodiments 1 to 23, wherein the widths of the annular curved surface zones decrease towards the edge of the multifocal contact lens (i.e., in a direction radiating from the central axis).
25. The multifocal contact lens of any one of embodiments 1 to 24, wherein the widths of the annular transition surface zones are substantially identical to each other.
26. The multifocal contact lens of any one of embodiments 1 to 25, wherein the heights of the annular transition surface zones are substantially identical to each other.
27. The multifocal contact lens of any one of embodiments 1 to 24, wherein the widths of the annular transition surface zones are different for different annular transition surface zones.
28. The multifocal contact lens of any one of embodiments 1 to 24 and 27, wherein the heights of the annular transition surface zones are different for different annular transition surface zones.
29. The multifocal contact lens of any one of embodiments 1-24, 27 and 28, wherein the heights of the annular transition surface zones are apodized.
30. The multifocal contact lens of any one of embodiments 1 to 29, wherein the circular or annular stepped-transition diffractive surface is continuous in second derivative.
31. The multifocal contact lens of any one of embodiments 1 to 30, wherein waves from the annular transition surface zones mix to create two distinct regions of constructive interference that correspond to two main foci of the multifocal contact lens.
32. The multifocal diffractive contact lens of any one of embodiment 1 to 31, wherein the multifocal contact lens has a diameter of from about 12.5 mm to about 15.5 mm (preferably between about 13.0 mm to about 15.2 mm, more preferably between about 13.5 mm to about 14.8 mm).
33. A method for making multifocal contact lenses, comprising the steps of:
   (1) obtaining a female lens mold half and a male mold half, wherein the female lens mold half has a FC molding surface defining the anterior surface of a multifocal contact lens to be molded, wherein the male lens mold half has a BC molding surface defining the posterior surface of the multifocal contact lens to be molded, wherein one of the FC and BC molding surfaces comprises a central circular portion defining a circular stepped-transition diffractive surface zone on the anterior or posterior surface of the multifocal contact lens to be molded, wherein the central circular portion is concentric with the central axis of the female or male mold half, wherein the male lens mold half and the female lens mold half are configured to receive each other such that a lens-molding cavity is formed between the FC and BC molding surfaces when the female lens mold half is closed with the male lens mold half;
   (2) dispensing a lens-forming composition onto the FC molding surface of the female mold half;
   (3) mating and closing the female mold half with the male mold half to form a molding assembly with the lens-forming composition in the lens-molding cavity;
   (4) curing actinically or thermally the lens-forming composition in the lens-molding cavity of the molding assembly to form a multifocal contact lens;
   (5) removing the multifocal contact lens from the molding assembly; and
   (6) subjecting the multifocal contact lens to post-molding processes including one or more processes selected from the group consisting of extraction, hydration, surface treatment, packaging, sterilization, and combinations thereof.
34. A method for making multifocal contact lenses, comprising the steps of:
   (1) obtaining a female lens mold half, a male insert mold half and a male lens mold half, wherein the female lens mold half has a first molding surface defining the anterior surface of a multifocal contact lens to be molded and the front convex surface of a diffractive insert to be molded, wherein the male insert mold half has a second molding surface that defines the back concave surface of the diffractive insert to be molded and comprises a circular or annular portion defining a stepped-transition diffractive surface, wherein the male lens mold half has a third molding surface defining the posterior surface of the multifocal contact lens to be molded, wherein the male insert mold half and the female lens mold half are configured to receive each other such that an insert-molding cavity is formed between the second molding surface and a central portion of the first molding surface when the female lens mold half is closed with the male insert mold half, wherein the male lens mold half and the female lens mold half are configured to receive each other such that a lens-molding cavity is formed between the first and third molding surfaces when the female lens mold half is closed with the male lens mold half;
   (2) dispensing an amount of an insert-forming composition on the central portion of the first molding surface of the female lens mold half,
   (3) placing the male insert mold half on top of the insert-forming composition in the female lens mold half and closing the male insert mold half and the female lens mold half to form a first molding assembly comprising the insert-forming composition within the insert-molding cavity;
   (4) curing the insert-forming composition in the insert-molding cavity of the first molding assembly to form the diffractive insert made of a second crosslinked polymeric material formed from the insert-forming composition and comprising the stepped-transition diffractive surface created on the back concave surface;
   (5) separating the first molding assembly obtained in step (4) into the male insert mold half and the female lens mold half with the diffractive insert that is adhered onto the central portion of the first molding surface;
   (6) dispensing a lens-forming composition in the female lens mold half in an amount sufficient for filling the lens-molding cavity;
   (7) placing the male lens mold half on top of the lens-forming composition in the female lens mold half and closing the male lens mold half and the female lens mold half to form a second molding assembly comprising the lens-forming composition and the diffractive insert immersed therein in the lens-molding cavity;
   (8) curing the lens-forming composition with the diffractive insert immersed therein in the lens-molding cavity of the second molding assembly to form a multifocal contact lens that comprise a first crosslinked polymeric material (lens bulk material) formed from the lens-forming composition and the diffractive insert embedded partially in the first crosslinked polymeric material;
   (9) separating the second molding assembly obtained in step (8) into the male lens mold half and the female lens mold half, with the multifocal contact lens adhered on a lens-adhered mold half which is one of the female and male lens mold halves;
   (10) removing the multifocal contact lens from the lens-adhered lens mold half; and
   (11) subjecting the embedded multifocal contact lens to post-molding processes including one or more processes selected from the group consisting of extraction, hydration, surface treatment, packaging, sterilization, and combinations thereof.
35. A method for making multifocal contact lenses, comprising the steps of:
   (1) obtaining a female insert mold half, a male lens mold half and a female lens mold half, wherein the female insert mold half has a fourth molding surface that defines the front convex surface of a diffractive insert to be molded and that comprises a circular or annular portion defining a stepped-transition diffractive surface, wherein the male lens mold half has a third molding surface defining the posterior surface of a multifocal contact lens to be molded, wherein the female lens mold half has a first molding surface defining the anterior surface of the multifocal contact lens to be molded, wherein the female insert mold half and the male lens mold half are configured to receive each other such that an insert-molding cavity is formed between the fourth molding surface and a central portion of the third molding surface when the female insert mold half is closed with the male lens mold half, wherein the female lens mold half and the male lens mold half are configured to receive each other such that a lens-molding cavity is formed between the first and third molding surfaces when the second female mold half is closed with the male mold half;
   (2) dispensing an amount of an insert-forming composition on the central portion of the first molding surface of the female lens mold half;
   (3) placing the male insert mold half on top of the insert-forming composition in the female lens mold half and closing the male insert mold half and the female lens mold half to form a first molding assembly comprising the insert-forming composition within the insert-molding cavity;
   (4) curing the insert-forming composition in the insert-molding cavity of the first molding assembly to form the diffractive insert made of a second crosslinked polymeric material formed from the insert-forming composition and comprising the stepped-transition diffractive surface created on the front convex surface;
   (5) separating the first molding assembly obtained in step (4) into the male insert mold half and the female lens mold half with the diffractive insert that is adhered onto the central portion of the first molding surface;
   (6) dispensing a lens-forming composition in the female lens mold half in an amount sufficient for filling the lens-molding cavity;
   (7) placing the male lens mold half on top of the lens-forming composition in the female lens mold half and closing the male lens mold half and the female lens mold half to form a second molding assembly comprising the lens-forming composition and the diffractive insert immersed therein in the lens-molding cavity;
   (8) curing the lens-forming composition with the diffractive insert immersed therein in the lens-molding cavity of the second molding assembly to form a multifocal contact lens that comprise a first crosslinked polymeric material (lens bulk material) formed from the lens-forming composition and the diffractive insert embedded partially in the first crosslinked polymeric material;
   (9) separating the second molding assembly obtained in step (8) into the male lens mold half and the female lens mold half, with the multifocal contact lens adhered on a lens-adhered mold half which is one of the female and male lens mold halves;
   (10) removing the multifocal contact lens from the lens-adhered lens mold half; and
   (11) subjecting the multifocal contact lens to post-molding processes including one or more processes selected from the group consisting of extraction, hydration, surface treatment, packaging, sterilization, and combinations thereof.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A multifocal contact lens, comprising:
an anterior surface; an opposite posterior surface; a central axis; a first crosslinked polymeric material that constitutes at least 60% by weight of the multifocal diffractive contact lens in dry state and has a first refractive index; and a circular or annular diffractive insert that is made of a second crosslinked polymeric material having a second refractive index and that is concentric with the central axis and embedded completely or partially in the first crosslinked polymeric material,
wherein the second refractive index is at least 0.03 higher than the first refractive index,
wherein the circular or annular diffractive insert comprises a front convex surface and an opposite back concave surface, wherein at least one of the front convex and back concave surfaces is buried inside the multifocal contact lens and directly in contact with the first crosslinked polymeric material and is designated as a buried surface of the circular or annular diffractive insert, wherein the buried surface of the circular or annular diffractive insert has a monotonically increasing surface sagitta (SAG) profile in a direction radiating from the central axis, wherein the circular diffractive insert has a diameter of from about 2.0 mm to about 7.5 mm and comprises a circular stepped-transition diffractive surface on the buried surface, wherein the annular diffractive insert has an inner diameter of from about 0.5 mm to about 3.0 mm and an outer diameter of about 7.5 mm or less and comprises an annular stepped-transition diffractive surface on the buried surface, wherein the circular or annular stepped-transition diffractive surface provides at least one first refractive optical power for a distant focus and at least one diffractive optical power which is an ADD power needed for a near focus.

2. The multifocal contact lens of claim 1, wherein the front convex surface of the circular or annular diffractive insert merges with and is integral part of the anterior surface of the multifocal contact lens, wherein the circular or annular stepped-transition diffractive surface is on the back concave surface of the circular or annular diffractive insert.

3. The multifocal contact lens of claim 1, wherein the back concave surface of the circular or annular diffractive insert merges with and is integral part of the posterior surface of the multifocal contact lens, wherein the circular or annular stepped-transition diffractive surface is on the front convex surface of the circular or annular diffractive insert.

4. The multifocal contact lens of claim 1, wherein the first crosslinked polymeric material is a first non-silicone hydrogel material or a first silicone hydrogel material, wherein the second crosslinked polymeric material is a second non-silicone hydrogel material, a second silicone hydrogel material, or a second rigid gas permeable material.

5. The multifocal contact lens of claim 4, wherein the annular stepped-transition diffractive surface comprises a plurality of annular curved surface zones and a plurality of annular transition zones, wherein the plurality of the annular curved surface zone and the plurality of the annular transition zones all are concentric with the central axis, wherein each of the plurality of the annular transition zones creates one sharp change in SAG between two adjoining annular curved surface zones, wherein the annular transition zones optically function to provide diffractive optical properties whereas the circular curved central surface zone and the annular curved surface zones provide refractive optical properties.

6. The multifocal contact lens of claim 4, wherein the circular stepped-transition diffractive surface comprises one circular curved central surface zone, a plurality of annular curved surface zones, and a plurality of annular transition zones, wherein the circular curved central surface zone, the plurality of the annular curved surface zone and the plurality of the annular transition zones all are concentric with the central axis, wherein each of the plurality of the annular transition zones creates one sharp change in SAG between the circular curved central surface zone and nearest annular curved surface zone or between two adjoining annular curved surface zones, wherein the annular transition zones optically function to provide diffractive optical properties whereas the circular curved central surface zone and the annular curved surface zones provide refractive optical properties.

7. The multifocal contact lens of claim 4, wherein the circular curved central surface zone and the annular curved surface zones are spherical or aspherical surfaces, wherein the curvatures of the circular curved surface zone and the annular curved surface zones are different from each other or substantially identical to each other.

8. The multifocal contact lens of claim 4, wherein the annular transition surface zones independent of one another have a width of about 0.1 mm or less.

9. The multifocal contact lens of claim 4, wherein the circular or annular stepped-transition diffractive surface comprise at least 3 annular transition surface zones.

10. The multifocal contact lens of claim 4, wherein the widths of the annular curved surface zones decrease towards the edge of the multifocal contact lens.

11. The multifocal contact lens of claim 4, wherein the widths of the annular transition surface zones are substantially identical to each other.

12. The multifocal contact lens of claim 4, wherein the heights of the annular transition surface zones are substantially identical to each other.

13. The multifocal contact lens of claim 4, wherein the widths of the annular transition surface zones are different for different annular transition surface zones.

14. The multifocal contact lens of claim 4, wherein the heights of the annular transition surface zones are different for different annular transition surface zones.

15. The multifocal contact lens of claim 4, wherein the heights of the annular transition surface zones are apodized.

16. The multifocal contact lens of claim 4, wherein the circular or annular stepped-transition diffractive surface is continuous in second derivative.

17. The multifocal contact lens of claim 4, wherein waves from the annular transition surface zones mix to create two distinct regions of constructive interference that correspond to two main foci of the multifocal contact lens.

18. A method for making multifocal contact lenses, comprising the steps of:
(1) obtaining a female lens mold half, a male insert mold half and a male lens mold half, wherein the female lens mold half has a first molding surface defining the anterior surface of a multifocal contact lens to be molded and the front convex surface of a diffractive insert to be molded, wherein the male insert mold half has a second molding surface that defines the back concave surface of the diffractive insert to be molded and comprises a circular or annular portion defining a stepped-transition diffractive surface, wherein the male lens mold half has a third molding surface defining the posterior surface of the multifocal contact lens to be molded, wherein the male insert mold half and the female lens mold half are configured to receive each other such that an insert-molding cavity is formed between the second molding surface and a central portion of the first molding surface when the female lens mold half is closed with the male insert mold half, wherein the male lens mold half and the female lens mold half are configured to receive each other such that a lens-molding cavity is formed between the first and third molding surfaces when the female lens mold half is closed with the male lens mold half;
(2) dispensing an amount of an insert-forming composition on the central portion of the first molding surface of the female lens mold half;
(3) placing the male insert mold half on top of the insert-forming composition in the female lens mold half and closing the male insert mold half and the female lens mold half to form a first molding assembly comprising the insert-forming composition within the insert-molding cavity;
(4) curing the insert-forming composition in the insert-molding cavity of the first molding assembly to form the diffractive insert made of a second crosslinked polymeric material formed from the insert-forming composition and comprising the stepped-transition diffractive surface created on the back concave surface;
(5) separating the first molding assembly obtained in step (4) into the male insert mold half and the female lens mold half with the diffractive insert that is adhered onto the central portion of the first molding surface;
(6) dispensing a lens-forming composition in the female lens mold half in an amount sufficient for filling the lens-molding cavity;
(7) placing the male lens mold half on top of the lens-forming composition in the female lens mold half and closing the male lens mold half and the female lens mold half to form a second molding assembly comprising the lens-forming composition and the diffractive insert immersed therein in the lens-molding cavity;
(8) curing the lens-forming composition with the diffractive insert immersed therein in the lens-molding cavity of the second molding assembly to form a multifocal contact lens that comprise a first crosslinked polymeric material (lens bulk material) formed from the lens-forming composition and the diffractive insert embedded partially in the first crosslinked polymeric material;
(9) separating the second molding assembly obtained in step (8) into the male lens mold half and the female lens mold half, with the multifocal contact lens adhered on a lens-adhered mold half which is one of the female and male lens mold halves;
(10) removing the multifocal contact lens from the lens-adhered lens mold half, and
(11) subjecting the embedded multifocal contact lens to post-molding processes including one or more processes selected from the group consisting of extraction, hydration, surface treatment, packaging, sterilization, and combinations thereof.

19. A method for making multifocal contact lenses, comprising the steps of:
(1) obtaining a female insert mold half, a male lens mold half and a female lens mold half, wherein the female insert mold half has a fourth molding surface that defines the front convex surface of a diffractive insert to be molded and that comprises a circular or annular portion defining a stepped-transition diffractive surface, wherein the male lens mold half has a third molding surface defining the posterior surface of a multifocal contact lens to be molded, wherein the female lens mold half has a first molding surface defining the anterior surface of the multifocal contact lens to be molded, wherein the female insert mold half and the male lens mold half are configured to receive each other such that an insert-molding cavity is formed between the fourth molding surface and a central portion of the third molding surface when the female insert mold half is closed with the male lens mold half, wherein the female lens mold half and the male lens mold half are configured to receive each other such that a lens-molding cavity is formed between the first and third molding surfaces when the second female mold half is closed with the male mold half;
(2) dispensing an amount of an insert-forming composition on the central portion of the first molding surface of the female lens mold half;
(3) placing the male insert mold half on top of the insert-forming composition in the female lens mold half and closing the male insert mold half and the female lens mold half to form a first molding assembly comprising the insert-forming composition within the insert-molding cavity;
(4) curing the insert-forming composition in the insert-molding cavity of the first molding assembly to form the diffractive insert made of a second crosslinked polymeric material formed from the insert-forming composition and comprising the stepped-transition diffractive surface created on the front convex surface;
(5) separating the first molding assembly obtained in step (4) into the male insert mold half and the female lens mold half with the diffractive insert that is adhered onto the central portion of the first molding surface;
(6) dispensing a lens-forming composition in the female lens mold half in an amount sufficient for filling the lens-molding cavity;
(7) placing the male lens mold half on top of the lens-forming composition in the female lens mold half and closing the male lens mold half and the female lens mold half to form a second molding assembly comprising the lens-forming composition and the diffractive insert immersed therein in the lens-molding cavity;
(8) curing the lens-forming composition with the diffractive insert immersed therein in the lens-molding cavity of the second molding assembly to form a multifocal contact lens that comprise a first crosslinked polymeric material (lens bulk material) formed from the lens-forming composition and the diffractive insert embedded partially in the first crosslinked polymeric material;
(9) separating the second molding assembly obtained in step (8) into the male lens mold half and the female lens mold half, with the multifocal contact lens adhered on a lens-adhered mold half which is one of the female and male lens mold halves;
(10) removing the multifocal contact lens from the lens-adhered lens mold half; and
(11) subjecting the multifocal contact lens to post-molding processes including one or more processes selected from the group consisting of extraction, hydration, surface treatment, packaging, sterilization, and combinations thereof.
